(19) United States
(12) Patent Application Publication
(10) Pub. No.: US 2005/0033603 A1
(43) Pub. Date: Feb. 10, 2005

(54) Hospital information system

(75) Inventors: Hitoshi Suzuki, Tokyo (JP); Shinichi Omori, Tokyo (JP); Kazuhiro Akiyama, Tokyo (JP); Yasuyuki Fukuhara, Tokyo (JP)

Correspondence Address: SCULLY SCOTT MURPHY & PRESSER, PC, 400 GARDEN CITY PLAZA, GARDEN CITY, NY, 11530, US

(73) Assignee: OLYMPUS OPTICAL CO., LTD., TOKYO (JP)

(21) Appl. No.: 10/650,615

(22) Filed: Aug. 28, 2003

(30) Foreign Application Priority Data
Aug. 29, 2002 (JP) 2002-252062
Aug. 29, 2002 (JP) 2002-252063
Aug. 29, 2002 (JP) 2002-252064
Mar. 20, 2003 (JP) 2003-078192
Mar. 26, 2003 (JP) 2003-086215
Mar. 31, 2003 (JP) 2003-095882

(51) Int. Cl. G06F 17/60

(52) U.S. Cl. 705/2

(57) ABSTRACT

An information system for use in a hospital includes a mobile terminal for inputting and outputting data relating to medical activities at an execution site of the medical activities in the hospital, a hospital information management system for managing information in the hospital, and a server for controlling communications of data relating to medical activities between the mobile terminal and the hospital information management system.

### CROSS REFERENCE TO RELATED APPLICATION

This application is based upon and claims the benefit of priority from the prior Japanese Applications No. 2002-252062, filed Aug. 29, 2002; No. 2002-252063, filed Aug. 29, 2002; No. 2002-252064, filed Aug. 29, 2002; No. 2003-78192, filed Mar. 20, 2003; No. 2003-86215, filed Mar. 26, 2003; and No. 2003-95882, filed Mar. 31, 2003, the entire contents all of which are incorporated herein by reference.

### BACKGROUND OF THE INVENTION

1. Field of the Invention

The present invention relates to a hospital information system for support of smooth medical activities by inputting/outputting data at an execution site of medical activities using a mobile terminal.

2. Description of the Related Art

Conventionally, regardless of execution site of medical activities, there have been no systems suggested for correctly recording an execution record of medical activities.

For example, when a site at which medical activities such as an endoscopic examination, etc. are performed is specified, and a patient visits the specified site to have the medical activities, the system for recording the medical activities is mounted at the site, and the medical activities performed there can be recorded.

However, when executors (nurses and doctors) visit the hospital room of an inpatient to sequentially visit hospital rooms to perform appropriate medical activities on each patient, the medical activities are mainly recorded on a paper medium, and there have been no systems suggested for recording the medical activities in a database.

Therefore, it has conventionally been necessary to collect the recorded contents on paper media to collect data of medical activities ever performed. Furthermore, the recorded contents on paper media have to be checked or information has to be communicated among persons involved so as to confirm the contents of medical activities, the status of medical activities such as the progress, the result, etc.

Furthermore, although there has conventionally been any systems for recording medical activities, they only allow medical staff to perform medical activities, return to predetermined places such as their own offices, staff rooms, etc., and then input the execution contents. Thus, there have been no systems for recording the execution contents of medical activities on the spot and immediately after they are performed.

Therefore, since some time is required to record medical activities after they are performed, it has been difficult to grasp in real time the contents, progress, results, etc. of the medical activities.

Furthermore, in the recording system in which medical activities are recorded some time after they are performed, there frequently are differences between what are performed and what are recorded, and there is the problem that it is difficult to correctly record medical activities.

To solve the above-mentioned problems, Japanese Patent Application Laid-open No. 8-106500 has suggested the technology of inputting the medical activities performed on a patient into a mobile input terminal (mobile terminal) and managing each of the medical activities using a host computer based on the data of the input medical activities.

The suggested technology is used in real time by a nurse accompanying a doctor according to a record instruction from the doctor after various medical activities are performed by the doctor. Using the technology, an erroneous record, which can be made in the conventional record made some time after medical activities are performed, can be avoided. As a result a correct record can be made and an instruction of a doctor can be input on the spot immediately after it is given from a doctor to a nurse, thereby successfully reducing a load of a nurse.

Recently, in addition to the above-mentioned situation, not only executed medical activities are to be recorded, but also a job schedule of medical activities has to be appropriately announced to a nurse, etc.

### SUMMARY OF THE INVENTION

A hospital information system which is one of the aspects of the present invention is configured by: a mobile terminal for inputting/outputting data of medical activities at an execution site of medical activities in a hospital; a hospital information management system for managing the information within the hospital; and a server for controlling the communications of data of medical activities between the mobile terminal and the hospital information management system.

The hospital information system according to another aspect of the present invention is configured by: a terminal for inputting execution data about executed medical activities; a hospital information management system for managing the execution data input by the terminal. The terminal inputs starting data indicating the start of medical activities as execution data, and separately inputs ending data indicating the termination of the medical activities as another execution data.

The hospital information system according to a further aspect of the present invention is configured by: a terminal for inputting/outputting data relating to medical activities; a server system for communicating the data with the terminal; and a hospital information management system for recording and centrally managing the information within a hospital to be communicated by the server system. The terminal is configured by a scheduled medical job data input/output unit for inputting and outputting data of normally scheduled medical jobs which is transmitted and indicated by the server system based on a medical order; and an unscheduled medical job data input/output unit for inputting and outputting data of medical jobs which occur unexpectedly without transmission and indication by the server.

The hospital information system according to a further aspect of the present invention is configured by: a terminal for inputting and outputting data by executing a program; and a server system for communicating the data with the terminal. The server system transmits to the terminal the data used in updating the program executed by the terminal when a request to terminate the connection between the terminal and the server system is transmitted from the terminal. The terminal updates the program based on the data transmitted from the server system and used in the update.

### BRIEF DESCRIPTION OF THE DRAWINGS

The present invention will be more apparent from the following detailed description when the accompanying drawings are referenced.

FIG. 1 is a block diagram showing the entire configuration of the hospital information system embodying the present invention;

FIG. 2 shows the configuration of the hardware of the PDA shown in FIG. 1;

FIG. 3 is a table showing each of medical activities from injection to examinations and measurement, and the contents of a job schedule in detail from the entry of an order of each medical activities to the execution;

FIG. 4 is a flowchart of the contents of the procedure of the process performed for an order entry, reference, and execution;

FIG. 5 shows the contents of a job schedule generated based on an order entry of an injection;

FIG. 6 is a flowchart of the contents of the procedure of the process of the PDA system used when an order entry for an injection is made;

FIG. 7 shows an example of a login screen of the PDA;

FIG. 8 shows an example of an entry screen of a job schedule list;

FIG. 9 shows an example of a display screen of a list of target patients in the working hours specified when the “entry with patient specified” button shown in FIG. 8 is pressed;

FIG. 10 shows an example of a ward selection screen displayed when the “entry with ward specified” button shown in FIG. 8 is pressed;

FIG. 11 shows an example of a working hours selection screen when the “working hours” button shown in FIG. 9 is pressed;

FIG. 12 shows an example of a selection display screen of a job schedule list;

FIG. 13 shows an example of a screen displayed when a selection item of the “today's job list” shown in FIG. 12 is selected;

FIG. 14 shows an example of a display screen displayed when a list of executed activities in the job schedule list is selected;

FIG. 15 shows the structure of job schedule data;

FIG. 16 is a flowchart of the process of the hospital information system when an injection is performed;

FIG. 17 shows an example of a screen when the selection item “job list for each item” is selected on the screen shown in FIG. 12, and the an injection item display state is entered;

FIG. 18 shows an example of a screen of a bottle check;

FIG. 19 is a table showing the format of an identification code of an injection bottle;

FIG. 20 shows an example of a display screen of a warning message displayed when an identification code of a wrong injection bottle is read;

FIG. 21 shows an example of a display screen used when a wristband check of a patient is made;

FIG. 22 shows an example of a display screen of a warning message displayed when a patient whose wristband has been checked is not related to the injection order;

FIG. 23 shows an example of a display screen displayed when an injection is performed;

FIG. 24 shows an example of a screen on which a dose of a medicine is input after performing an injection;

FIG. 25A is a flowchart of the process of starting a time-consuming instillation;

FIG. 25B is a flowchart of the process of finishing a time-consuming instillation;

FIG. 26 is a flowchart of the contents of the entire process of unscheduled medical jobs and normally ordered medical execution;

FIG. 27 shows a medical execution schedule screen of normally scheduled jobs to be executed during the today's working hours displayed on the PDA display screen when a user logs in to the system;

FIG. 28A shows an unscheduled input screen displayed on the PDA display screen;

FIG. 28B shows the identification code read screen;

FIG. 29A shows the measurement item selection screen displayed on the PDA display screen;

FIG. 29B shows the selection item check screen;

FIG. 30 shows the order strap selection screen displayed on the PDA display screen;

FIG. 31A shows the body temperature data input screen displayed on the display screen of the PDA;

FIG. 31B shows the pulse data input screen;

FIG. 31C shows the blood pressure data input screen;

FIG. 32A shows an example of data of a nursing order normally scheduled for a patient;

FIG. 32B shows an example of a nursing order made after an unscheduled examination on the first day;

FIG. 32C shows an example of a nursing order made when the condition of a patient suddenly changes;

FIG. 33 shows an example of a screen of medical execution according to an oral instruction displayed on the PDA when an order of a normally scheduled medical execution made according to an oral instruction is executed;

FIG. 34 shows the bottle label check screen displayed on the PDA display screen;

FIG. 35 shows the broken bottle label check screen displayed on the PDA display screen;

FIG. 36 shows the broken bottle check screen displayed on the PDA display screen;

FIG. 37 shows the broken bottle manual input screen displayed on the PDA display screen;

FIG. 38A shows the monitor display method of the hospital information system;

FIG. 38B shows a conventional monitor display method for information;

FIG. 39 shows the assignment of a storage area of a storage unit of the PDA;

FIG. 40 shows the procedure of the process of updating an application program used in the PDA 8 in the PDA system 4B;

FIG. 41 shows an example of a notification screen indicating that the program is being updated; and

FIG. 42 shows the procedure of the process of the logout process performed in the PDA 8.

### DESCRIPTION OF THE PREFERRED EMBODIMENTS

The embodiments of the present invention are described below by referring to the attached drawings.

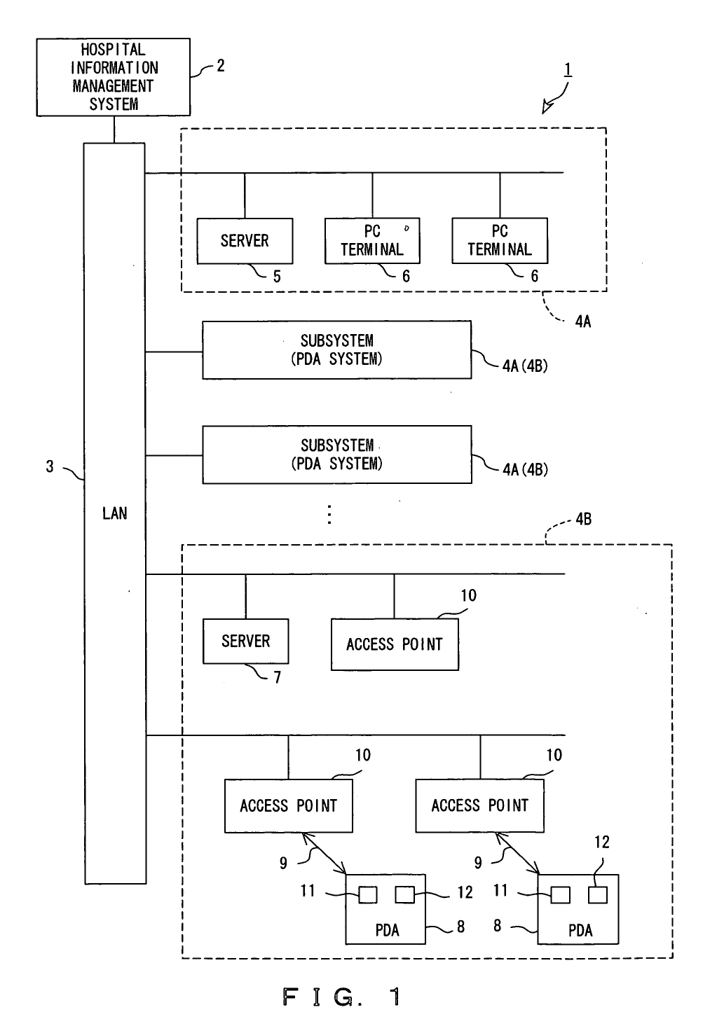

A hospital information system 1 according to an embodiment of the present invention shown in FIG. 1 comprises a hospital information management system 2 which is mounted in, for example, a hospital as medical facilities, and records and centrally manages the information in the hospital, and a plurality of subsystems, for example, a (first) subsystem 4A and a (second) subsystem 4B, connected to the hospital information management system 2 through, for example, a cable LAN (local area network) 3 and capable of communicating information through the LAN 3.

In the first subsystem 4A, a server 5 for performing control and information processing and a terminal which is a personal computer (hereinafter referred to as a PC for short) for inputting/outputting data, that is, a PC terminal 6, are connected through the cable LAN 3. The PC terminal 6 is a stationary terminal, and medical staff such as nurses, etc. and terminal users input, refer to, and check data in the place in which the PC terminal is provided.

The second subsystem (hereinafter referred to as a PDA system because a PDA is used in the system) 4B comprises a server 7 for performing control and information processing, a portable terminal such as a PDA (personal digital assistant) 8, etc. which can be carried and used by a medical staff such as a nurse, etc., and an access point 10 which is a data communications device capable of communicating data from the PDA 8 through a wireless LAN 9. The server 7 is connected to each access point 10 through the LAN 3.

The PDA 8 includes a wireless LAN card 11 as a data communications device capable of communicating data with the server 7 through the wireless LAN 9, and an identification code reader 12 as a device for reading identification information capable of reading characters and patterns such as graphics, etc. representing an identification code.

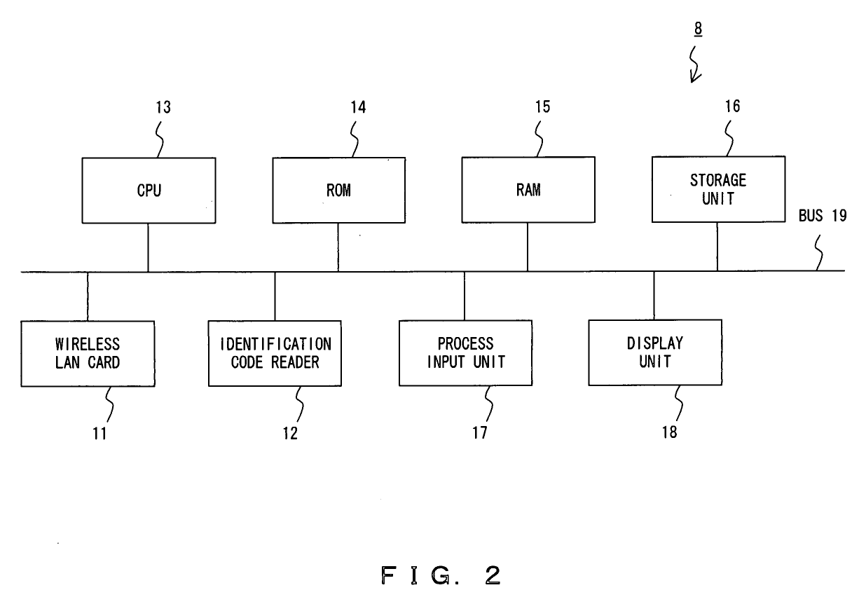

FIG. 2 shows the configuration of the hardware of the PDA 8.

In FIG. 2, the wireless LAN card 11, the identification code reader 12, a CPU 13, ROM 14, RAM 15, a storage unit 16, a process input unit 17, and a display unit 18 are interconnected through a bus 19, and can communicate data with each other under the control of the CPU 13.

The wireless LAN card 11 and the identification code reader 12 are described above. The identification code reader 12 can be an OCR (optical character reader) capable of optically reading a character, but can also be an image scanner for reading patterns such as a character, graphics, etc. as an image, a transponder capable of reading an identification code by wireless, etc.

The CPU (central processing unit) 13 controls the entire process of the PDA 8.

The ROM 14 is memory storing in advance a basic control program executed by the CPU 13. The CPU 13 performs basic control of the entire process of the PDA 8 by executing the basic control program when the PDA 8 is activated.

The RAM 15 is used as work memory when the CPU 13 executes various application programs stored in the storage unit 16, and can also be used as main memory used as a temporary storage area of various data as necessary.

The storage unit 16 is memory storing various application programs and data. The storage unit 16 can be semiconductor memory such as EEPROM (electrically erasable and programmable read only memory), etc. Especially, in the EEPROM, the stored contents can be electrically rewritten, and can be held without supply of power.

The process input unit 17 is, for example, a touch panel provided for the display unit 18, operated by a user of the PDA 8, detects the contents of the process, and transmits the contents of the process to the CPU 13.

The display unit 18 is, for example, a liquid display, displays various information transmitted from the CPU 13, and provides various information as visible data for a user.

Various data can be input and output by the identification code reader 12, the process input unit 17, and the display unit 18 by executing a predetermined application program by the CPU 13.

Although the communicable access range is restricted by the distance from the access point 10 because the PDA 8 is provided with the wireless LAN 9, the PDA 8 can access the hospital information management system 2 through the server 7 in an arbitrary place within the access range, obtain job schedule data described later, and display the obtained job schedule data on the display unit of the PDA 8.

When the PDA 8 provided with the identification code reader 12 allows an identification code used in various identification information to be read, a nurse, etc. carrying the PDA 8 can correctly, simply, and quickly input (read) various identification information such as an executor ID, a patient ID who is subjected to medical activities, an injection ID, etc.

The PDA 8 is waterproof and resistant to a medical solution, and is designed so that it can be easily operated at a medical site.

To be more practical the subsystems 4A and 4B are implemented as an outpatient system and a ward system in which an order such as an injection order, etc. is recorded, a medicine division system in which medicine is delivered in association with an order entry such as an injection order, etc., a medical system in which an accounting process, etc. is performed on medical activities, a nurse (station) system in which a nurse mixes medicines, etc. Especially in the nurse system and the ward system, each nurse carries the PDA 8, and can input/output medical activities information in an execution site of medical activities, that is, on the side of the bed of an inpatient. As a result, the status of medical activities can be recorded and grasped in real time.

That is, medical activities can be correctly recorded and grasped without a time lag from when the medical activities are executed at an execution site of the medical activities.

Furthermore, when medical activities are performed at an execution site of the medical activities as described above, a nurse can check the contents of the job schedule of the medical activities through the PDA 8. Since the contents of the job schedule can be first checked, and then the medical activities based on the job schedule can be performed, the (scheduled) medical activities to be performed can be correctly carried out with errors avoided.

Additionally, since the record of the contents of performed medical activities can be input at an execution site of the medical activities, the executed medical activities can be recorded immediately after the execution while checking the execution contents at the execution site. Therefore, the execution contents can be correctly recorded with errors avoided.

Furthermore, when medical activities are performed, the portable PDA 8 can be used to allow the contents of the job schedule of the medical activities to be easily referred to and checked in an arbitrary place. Therefore, medical activities can be smoothly performed. Although the contents of a job schedule are changed, the contents of a job schedule can be checked at the execution site immediately before the execution. Therefore, a change of the contents of a job schedule can be easily accepted.

Since the contents of medical activities can be correctly recorded in real time when the medical activities are executed, the system can be more appropriately improved by an analysis of the data recorded later.

In FIG. 1, a subsystem can be configured by a combination of the components of the subsystems 4A and 4B. Practically, for example, the subsystem (PDA system) 4B can be a stationary PC terminal 6.

The present embodiment described below relates to medical activities by a nurse among the functions of the hospital information system 1, that is, a nursing support function for nursing.

The nursing support function supports medical activities on the following nursing activities.
injection
nursing
treatment
examinations and measurement

An “injection” refers to a medical activity of giving an injection to a patient by a nurse. “Nursing” refers to a medical activity of measuring the temperature of a patient, taking care of a patient by a nurse by wiping the body of a patient, teaching how to take a bath in the hospital, etc. A “treatment” is a medical activity of a nursing treatment by a nurse by removing a catheter, etc. Furthermore, “examinations and measurement” refers to medical activities by a nurse by a blood test, a fluid test, etc.

An “injection” includes a “one-shot injection” which does not require a long time to complete the treatment, and an instillation which is a time-consuming treatment.

In the process of these medical activities, if an order instruction of an “injection”, “nursing”, a “treatment”, or “examinations and measurement” is issued by a doctor, and the PC terminal 6 transmits an order entry instruction to the hospital information management system 2, then the hospital information management system 2 receives the instruction, automatically generates job schedule data of each of the steps including an order entry, reception of instruction, . . . , and stop, and records the automatically generated data in the database (not shown in the attached drawings) in the hospital information management system 2.

That is, the hospital information management system 2 comprises the function of generating job schedule data, and the function of recording generated job schedule data in the database of the hospital information management system 2.

On the other hand, a nurse accesses the database from the PDA 8 through the server 7, downloads the job schedule data to the PDA 8, obtains the job schedule data, and stores (records) the data in the storage unit 16.

Then, by operating the process input unit 17 of the PDA 8, for example, a touch panel, the job schedule data recorded in the storage unit 16 can be listed on the display unit 18, that is, a liquid monitor, etc., thereby successfully referencing and grasping the progress of the job schedule data.

A nurse can refer to the contents of job schedule data or grasp the progress through the PC terminal 6.

An order entry is normally made through the PC terminal 6 of an outpatient system, etc.

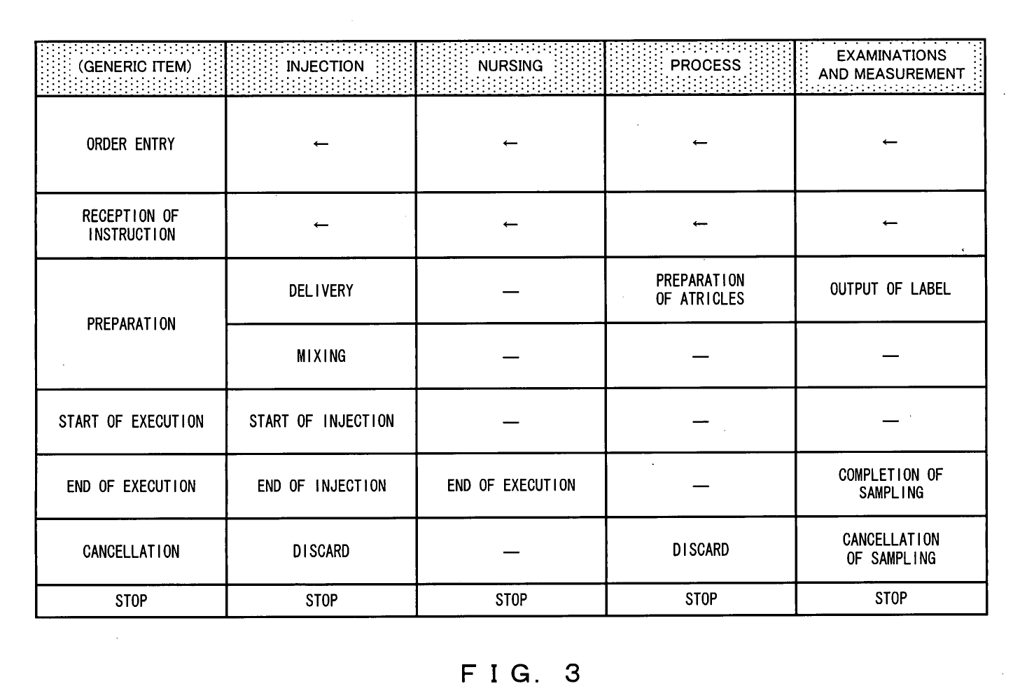

Each of the medical activities from “injection” to “examinations and measurement” is executed according to the job schedule including the steps of order entry, reception of instruction, . . . , etc. shown in the table in FIG. 3.

For example, when the medical activity “injection” is executed, an order entry of an injection is made at an instruction of a doctor, then each step of “reception of instruction” in response to the “order entry”, “delivery of medicine” and “mixing” (of medicines) for preparation of the injection, “start of injection”, and “end of injection” is executed. The steps of “cancellation” due to a broken injection bottle (instillation bottle) and “stop of injection” due to a change of the condition of a patient can be executed as necessary.

In the case of “nursing”, as indicated by the arrow, job schedule data of an order entry, reception of instruction, etc. is generated for nursing.

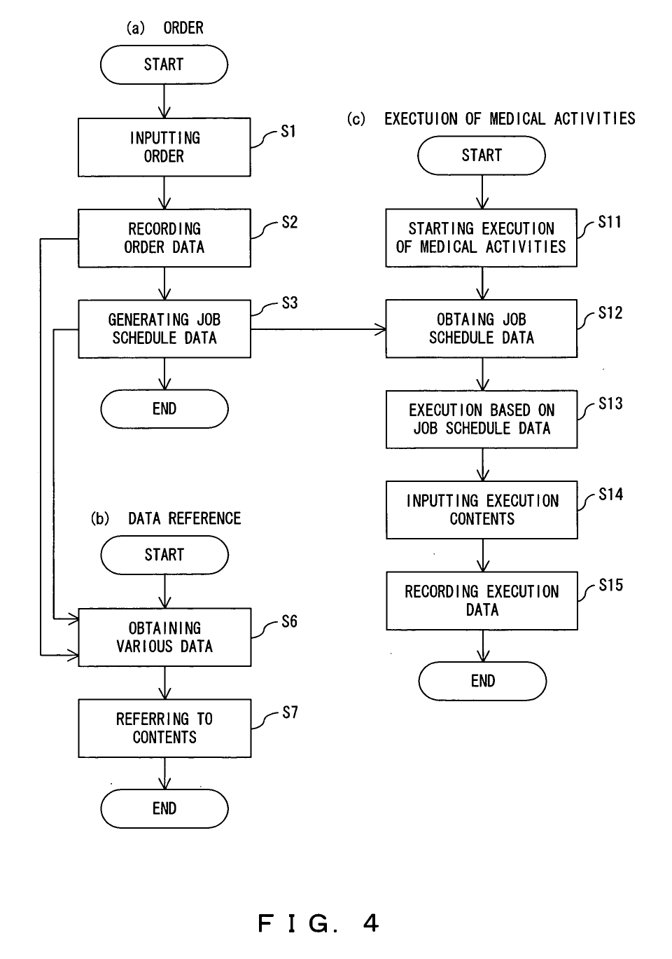

FIG. 4 is a flowchart of the common process in the entire system.

In FIG. 4, (A) shows a flowchart of the process for an order entry. In the flowchart of the process, an order relating to each medical activity in step S1 is specified and input through the PC terminal 6 of the outpatient system and possibly the ward system. The order data is recorded in the hospital information management system 2 in step S2.

When order data is recorded in the hospital information management system 2, the job schedule data of each step is generated and arranged in the vertical direction (step S3).

(B) shows a flowchart of the process for reference to job schedule data. In the flowchart of the process, each subsystem 4A (or 4B) obtains the job schedule data in step S6, thereby allowing the instruction contents and schedule contents of an order to be referred to in step S7. A nurse executes medical activities (medical jobs) according to the instruction and schedule.

(C) shows a flowchart of the process including the activities of a nurse when medical activities (medical jobs) are executed. When the execution of the medical activities is started in step S11, the PDA 8 obtains job schedule data in step S12 after the process performed by the nurse.

Based on the obtained job schedule data, the nurse goes to the bed at an execution site where the medical activities are to be executed, and executes the medical activities on the patient at the execution site in step S13.

When medical activities are executed, the nurse uses the portable PDA 8 to perform a process (job) of inputting the execution contents in step S14, the PDA 8 immediately records the execution data in the hospital information management system 2 in step S15.

When there is a change in the order contents, etc. in job schedule data, a change entry is made, and the change entry of the changed job schedule data is made in the hospital information management system 2.

Order data, and job schedule data and job execution data generated based on the order data are formed by an XML (extensible markup language) file, etc. defined by, for example, a tag having a hierarchical structure. The XML is obtained by extending the function of the HTML (hypertext markup language). Since the technology is well known, and the explanation is omitted here.

Since these order data job schedule data, and execution data can be referred to by the PC terminal 6, etc. of each subsystem 4A, a system user can check the order contents, schedule, progress, execution contents, etc. at any time.

By using the portable PDA 8, a user can freely check order contents, schedule, progress, execution contents, etc. at any time and in any place. When a nurse executes job-scheduled medical activities on a patient in the bed which is the execution site, the execution contents of the medical activities can be recorded in real time in the hospital information management system 2 through the PDA system 4B by inputting the execution contents of the medical activities corresponding to the job schedule into the PDA 8, thereby correctly accumulating and updating information about the medical activities.

When the execution contents of the medical activities are recorded, not only a time, but also the information about “who, where, what, how, and when” relating to the medical activities is recorded. Therefore, the analysis of the information can be carries out later in detail, and the job procedure and the job contents can be easily improved.

Described below is the system of inputting/outputting data to check the progress, execution contents, etc. of medical activities in each of the subsystems 4A and 4B.

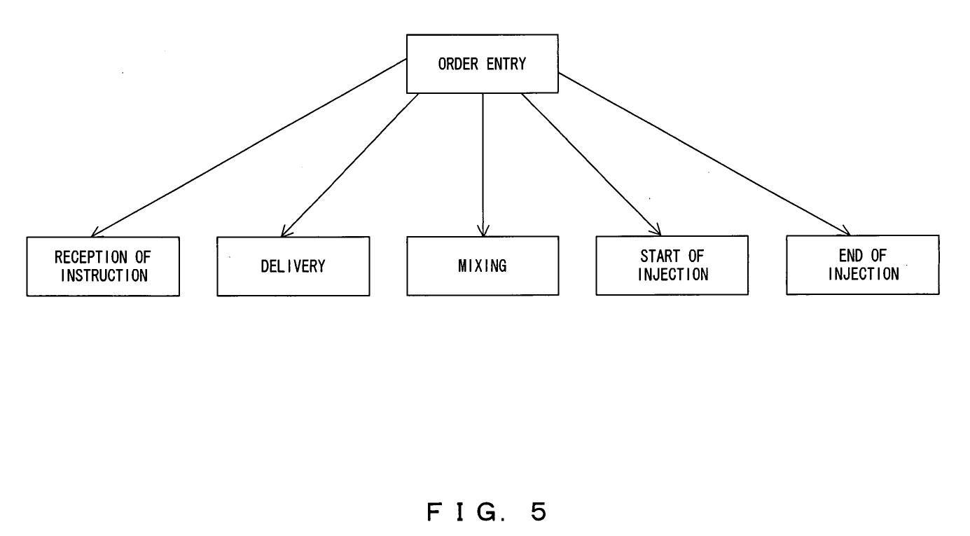

FIG. 5 shows the job schedule data generated by an injection order.

In the case of an injection, when an injection order is recorded, the following job schedule data is generated.
(1) Instruction receiving job in a ward (corresponding to “reception of instruction” shown in FIG. 5)
(2) Medicine delivering job in a medicine department (corresponding to “delivery” shown in FIG. 5)
(3) Mixing job of medicines in a ward (corresponding to “mixing” shown in FIG. 5)
(4) Injection starting job on a patient in a ward (corresponding to “start of injection” shown in FIG. 5)
(5) Injection terminating job on a patient in a ward (corresponding to “end of injection” shown in FIG. 5)

The execution of the injection order is completed by finishing the medical activities in the job schedule. Each job schedule is executed by the subsystem 4A or 4B, and more practically by the following subsystems.
“reception of instruction”→executed by a nurse in a ward system.
“delivery”→executed by a pharmacist in a medicine department system.
“mixing”→executed by a nurse in a ward system.
“start of injection” and “end of injection”→executed by a nurse in the PDA system 4B.

An injection includes both an instillation and a one-shot injection. In the case of an instillation, it takes a long time to give a dose of an injection solution to a patient. Therefore, it is common that the medical activity of starting the dose is executed independent of the medical activity of ending the dose. On the other hand, in the case of a one-shot injection, it takes a very short time to complete giving a dose of an injection solution. Therefore, the starting time and end time of the dose are almost the same times.

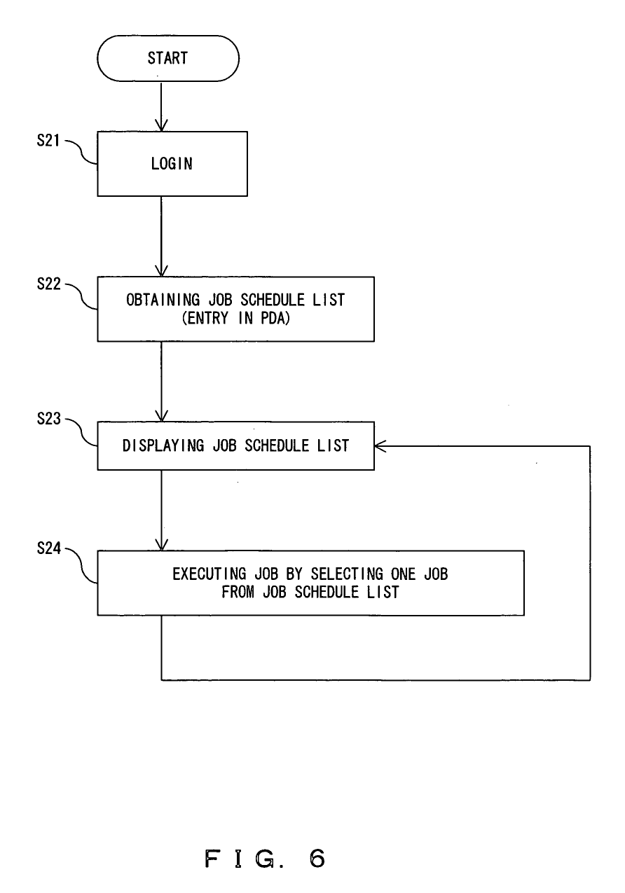

FIG. 6 is a flowchart of the process of the PDA system 4B when an injection is executed as a medical activity.

In the PDA system 4B, the portable PDA 8 is used, and a nurse carries the PDA 8 to the bed of a patient, and can check a job schedule and input a record of a job by the bed. Therefore, the PDA 8 can be used in inputting execution data of the start and the end of an injection.

Normally, a nurse first obtains his or her job schedule during the working hours using the PDA 8, and checks the job schedule, etc. of the day. Then, on the time of a scheduled job, the nurse goes to the bed of the patient, executes each medical activity, and inputs execution data of the medical activity using the PDA 8. The processes are described in detail by referring to FIG. 6.

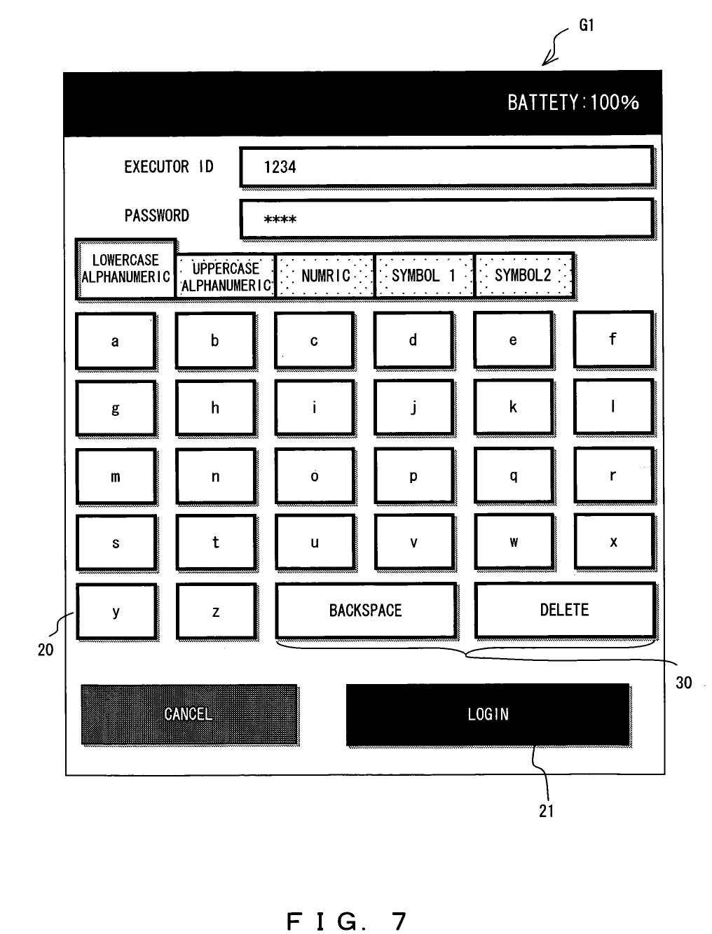

When the nurse powers up the PDA 8, the PDA 8 first performs a login process in step S21. Then, the PDA 8 displays the login screen G1 shown in FIG. 7.

On the login screen G1, the nurse performs a process of inputting an executor ID and a password.

On the login screen G1, when a staff who executes a medical activity reads an identification code as identification information written on his or her name plate, etc. using the identification code reader 12 provided for the PDA 8, the ID data read from the identification code is input to the executor ID column. Thus, using the identification code reader 12 provided for the PDA 8, an executor ID can be more easily input in a simple process.

A password can be input by touching the touch panel on the PDA 8 on which the screen of a keyboard 20 of alphabetical and numerical characters and symbols is displayed with a finger or a pen.

When an executor ID and a password are input, and a process of pressing a login button 21 is performed, the executor ID and the password are transmitted from the PDA 8 to the hospital information management system 2 through the server 7 for an inquiry. If the executor ID and the password are correct, the login process successfully terminates. If a wrong password, etc. is input, a backspace/delete button 30 is to be pressed to clear the input contents, and a correct password can be input.

When the login process is successfully performed, a job schedule list acquisition (entry in the PDA 8) process is started.

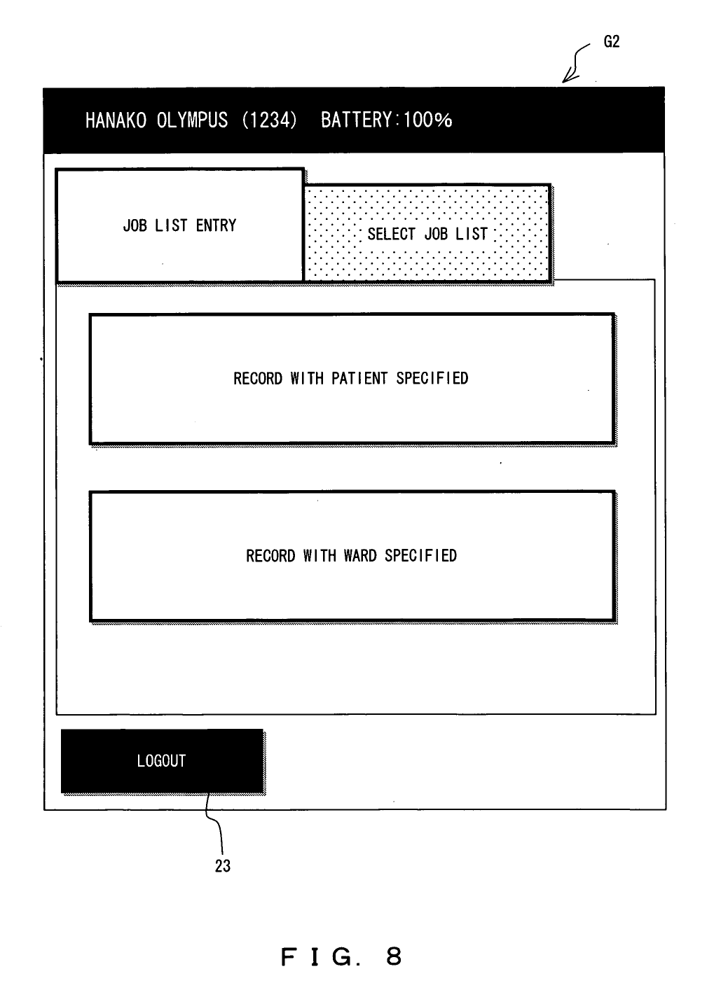

When the job schedule list acquisition process is started, the display of the PDA 8 is switched to the job schedule list entry screen G2 shown in FIG. 8.

On the job schedule list entry screen G2, a request to select an entry with a patient specified or an entry with a ward specified is displayed (the job schedule list is described as a “job list” for short on the display screen G2, etc. of the PDA 8).

The nurse specifies either obtaining a job schedule list with a patient specified or obtaining a job schedule list of all patients in a ward with an area, that is, a ward, of a patient. Thus, a nurse who executes medical activities can select or specify an appropriate job schedule list, and obtain a convenient selection screen. In FIG. 8, a nurse can press a logout button 23 (with a touch) to suspend obtaining the job schedule list.

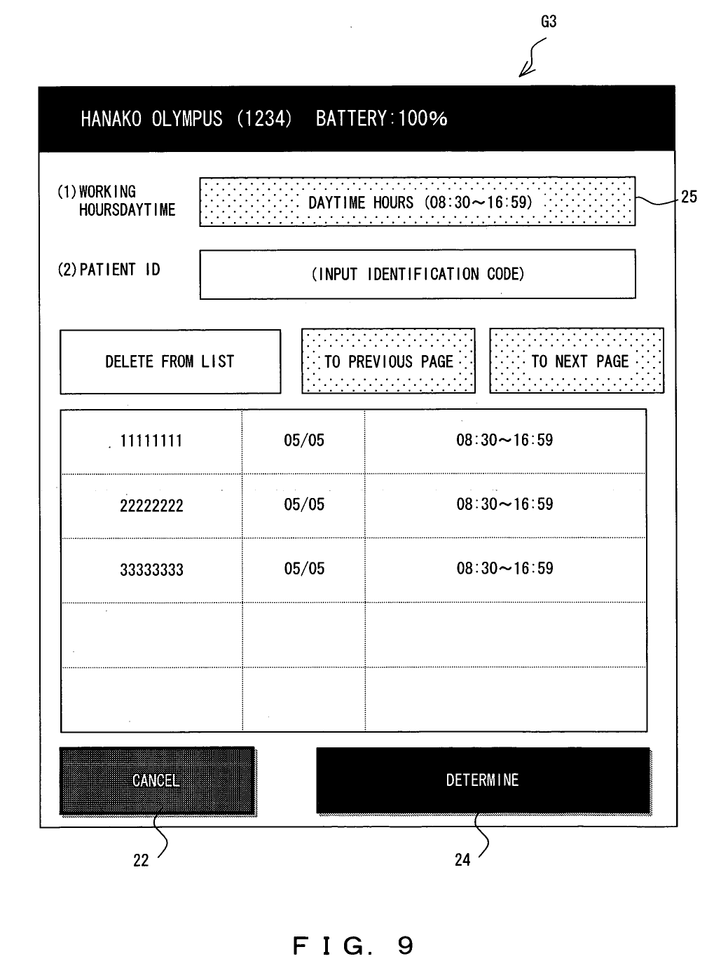

In FIG. 8, for example, when a nurse selects “entry with a patient specified”, the screen G3 shown in FIG. 9 is displayed.

On the screen G3, input columns (1) working hours and (2) patient ID are displayed. When a nurse specifies scheduled working hours (in this practical example, for example, the daytime hours 8:30˜16:59 are specified) and inputs an identification code of a patient ID, corresponding data is acquired from the data of the job schedule list recorded in the hospital information management system 2 to the PDA 8. Then, all target patients of the acquired job schedule list are listed on the screen G3.

The screen G3 shown in FIG. 9 shows the status of the acquired job schedule list in the working hours (08:30˜16:59) of a nurse for three patients (assigned respective patient IDs as identification codes as 11111111, 22222222, and 33333333). In this status, when a determination button 24 is pressed, the job schedule data of the medical activities on the three patients can be formally acquired on the PDA 8. A touch on a cancel button 22 can cancel the acquisition of the job schedules.

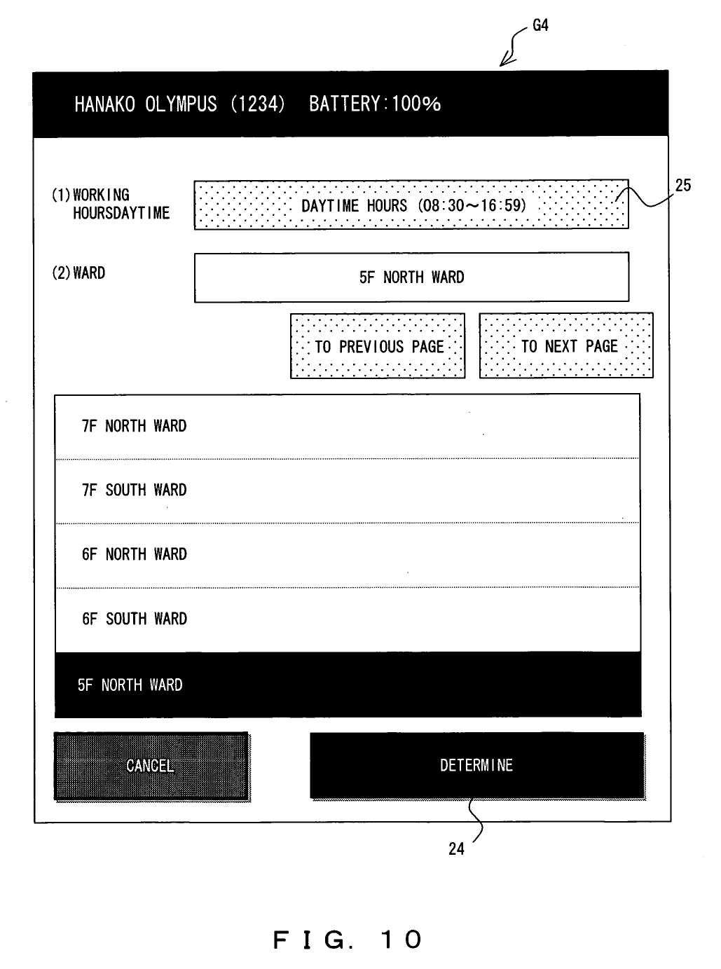

On the other hand, when a nurse selects an entry with a ward specified on the screen G2 shown in FIG. 8, the screen G4 shown in FIG. 10 is displayed.

On the screen G4, input columns (1) working hours and (2) ward are displayed. The nurse specifies the working hours and the name of a ward (for example, the north ward on the fifth floor), and presses the determination button 24. Thus, the nurse obtains a job schedule for each patient in the specified ward during the working hours of the nurse of the day.

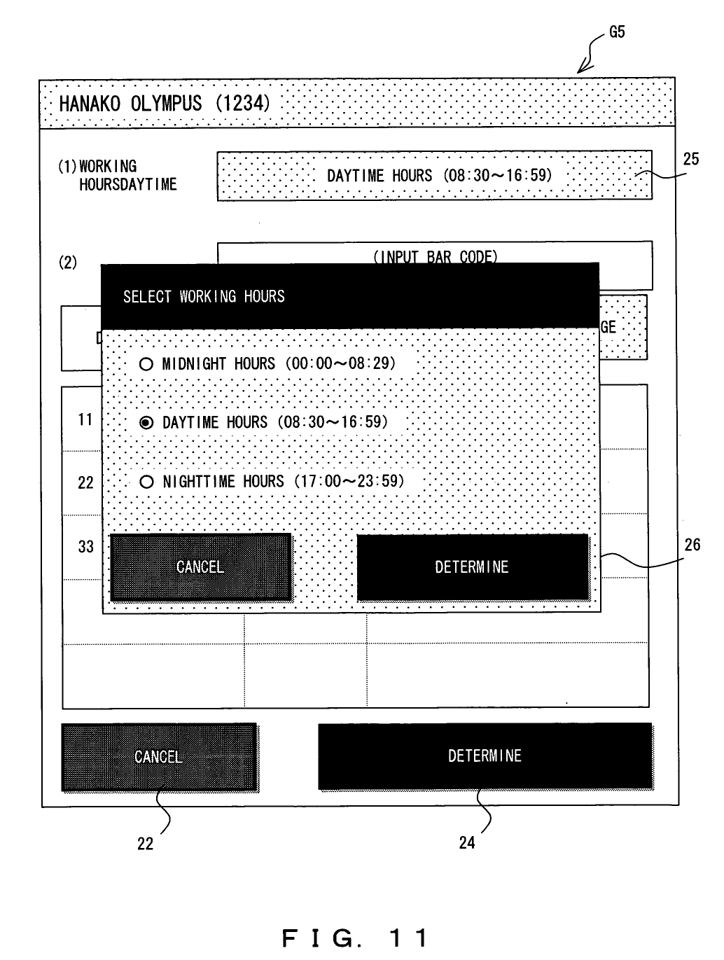

The input columns (1) of working hours shown in FIGS. 9 and 10 are shown by a button 25 in the present embodiment. When the button 25 is pressed, a window in which working hours can be specified is open, and the display of the PDA 8 displays the screen G5 shown in FIG. 11, for selection and designation of the working hours.

According to the present embodiment, the working hours can be midnight hours from 0:00 to 8:29, daytime hours from 8:30 to 16:59, and nighttime hours from 17:00 to 23:59. The working hours can be set variably.

In the window, the working hours including the login time are displayed at the center as default values, and two working hours are displayed above and below the default hours. Thus, desired working hours can be conveniently selected.

In the window, by the nurse selecting his or her working hours and performing the process of pressing a determination button 26, a job schedule list for each of the selected working hours can be acquired on the PDA 8.

In this case, the job schedule data in the range of one and half hours each before and after the working hours can also be acquired on the PDA 8 with the process performed when the execution of medical activities cannot be performed on schedule or with the process of taking over a job between staff in the working hours taken into account.

Furthermore, for the job schedule of “end of injection”, a job schedule data is acquired including the data of 24 hours before the injection because, in the case of an instillation requiring a medical activity of “start of injection” to be executed independent of a medical activity of “end of injection”, there can be a process of giving a dose of an instillation started in the previous working hours, and is to be completed during the current working hours.

When the process of acquiring the job schedule list is completed in step S22, the process of displaying the job schedule list is started in step S23.

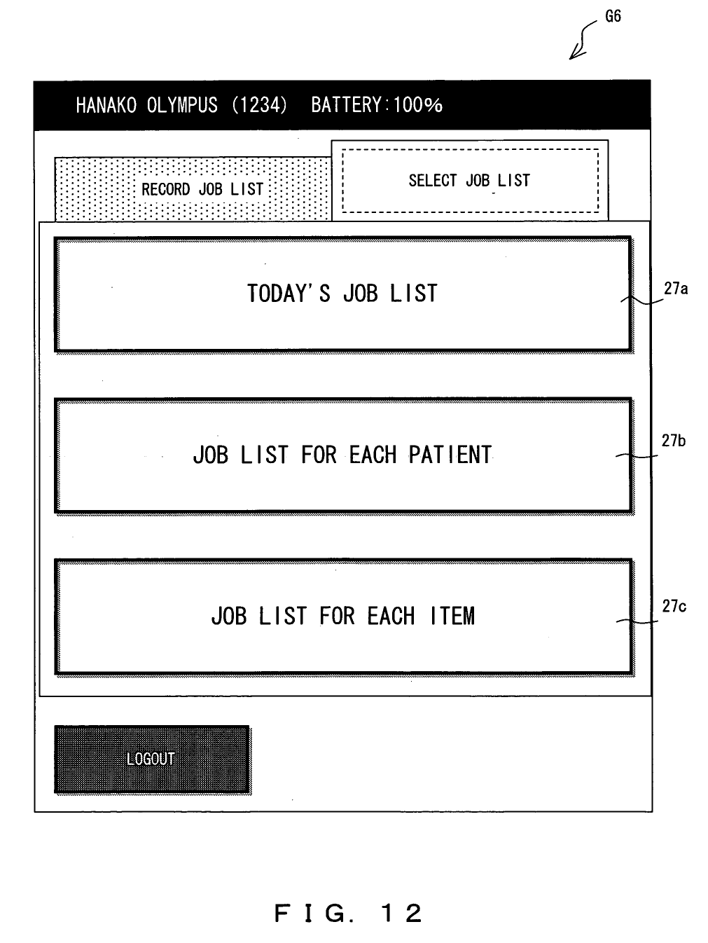

When the process of displaying a job schedule list is started, the PDA 8 displays a job schedule list display screen G6 shown in FIG. 12.

On the job schedule list display screen G6 shown in FIG. 12, the style of displaying a job schedule list is selected. That is, three selection items 27a “today's job list”, 27b “job list for each patient”, and 27c “job list for each item” are displayed.

When the selection item 27a “today's job list” is selected, all job schedules recorded in the PDA 8 are displayed.

When the selection item 27b “job list for each patient” is selected, only the job schedule list of the specified patient is displayed in the job schedules recorded in the PDA 8.

When the selection item 27c of the “job list for each item” is selected, only the job schedule list of the selected type of medical item is displayed in the job schedules recorded in the PDA 8.

Thus, job schedule data is temporarily recorded in the storage unit 16 of the PDA 8, and the list display (listing) of job schedule data is variable by the PDA 8. As a result, the frequency of an inquiry to the hospital information management system 2 becomes lower, thereby reducing the traffic related to data communications and shortening the time required to display a job schedule.

Furthermore, a nurse can selectively display desired job schedule data in an energy saving manner by using the job schedule data acquired in the PDA 8. That is, the job schedule data only relating to the specified patient can be displayed from the storage unit 16 in the PDA 8 by specifying working hours, a patient, a job item, etc. without sequentially accessing the database of the hospital information management system 2 through the PC terminal 6, that is, in the energy saving manner in which the wireless LAN card 11 is put in an inactive state without frequently putting the wireless LAN card 11 in an active state (therefore, the CPU in the PDA 8 puts the wireless LAN card 11 in the inactive state when the connection to the server 7 is not required at a process instruction of the PDA 8, thereby realizing power saving).

As another variation example, after the PDA 8 logs in the hospital information management system 2 and accesses a database in step S21 shown in FIG. 6, the process of displaying a job list in step S23 can be performed without acquiring the job schedule list in step S22.

Especially when the latest information only about a specific item is to be checked, target information can be checked within a short time. By increasing options, the staff using the PDA 8 can display and check job schedule data in the display style appropriate for the staff.

Thus, in the present embodiment, the display contents of job schedule data can be selected, and the selection instruction can be issued when the PDA 8 as a portable terminal acquires job schedule data, and also when it indicates displaying job schedule data. Therefore, a number of users of the PDA 8 can use the above-mentioned systems.

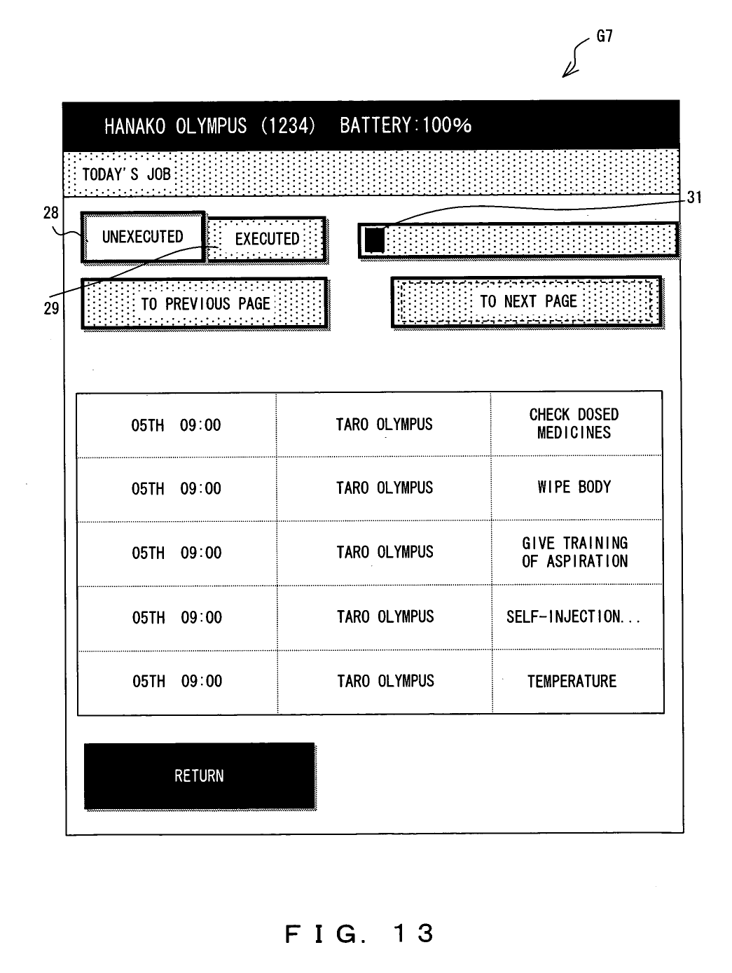

If the selection item 27a of the today's job list is selected on the screen G6 shown in FIG. 12, the display screen G7 shown in FIG. 13 is displayed.

The screen G7 is displayed with an “unexecuted” tab 28 displaying a job schedule list of unexecuted jobs separate from an “executed” tab 29 displaying a job schedule list of executed jobs.

That is, in the acquired job schedule list, an unexecuted job is displayed by the “unexecuted” tab 28, and an executed job is displayed by the “executed” tab 29. Therefore, in a job schedule, unexecuted jobs and executed jobs can be clearly displayed.

On the upper right of the screen, a progress bar 31 is displayed, and the rate of executed jobs in all scheduled jobs for the user is displayed by the gauge of the bar. When the bar reaches the rightmost position of the display column, it indicates that all jobs have been completed. The gauge shows the computation result of the ratio of the number of executed jobs to the number of all jobs.

Each job schedule is displayed in one line of the list on the screen having the “unexecuted” tab 28, and a scheduled time, a patient name, and a job name are displayed. By selecting one line of a schedule list, a screen for input of the execution described later is displayed.

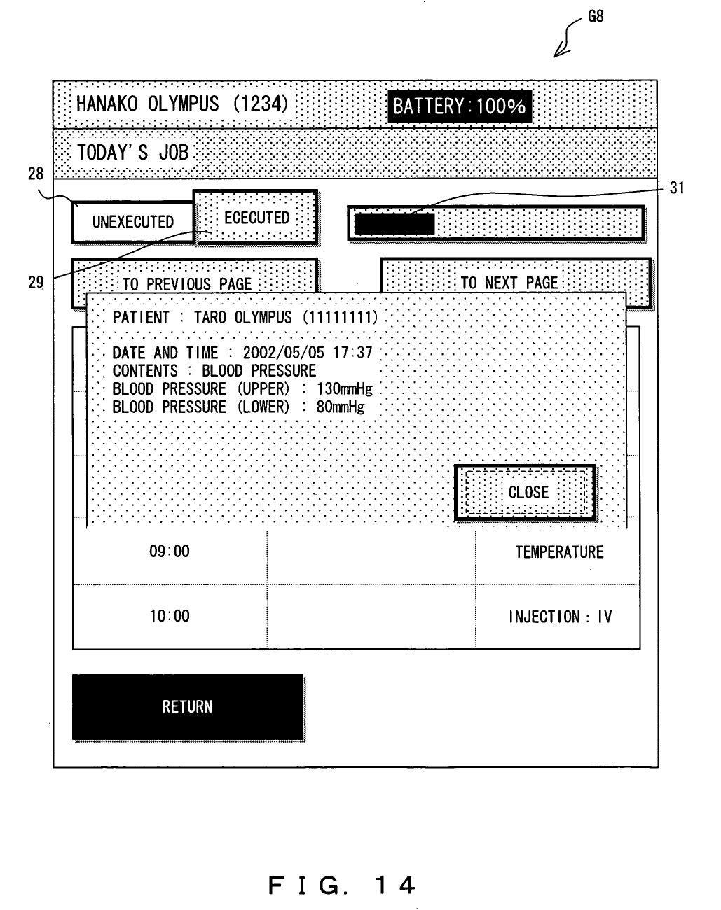

A schedule list displaying executed jobs is switched to a list on the screen having the “executed” tab 29. When a line of a list is selected in the list on the screen having the “executed” tab 29, the executed contents (execution data) on the screen G8 shown in FIG. 14 are displayed as overlay (on the screen G7 shown in FIG. 13).

In an example of executed contents, medical activities of blood pressure measurement are executed, and input results of measurement values of a blood pressure (high) and a blood pressure (low) are displayed.

When an unexecuted job schedule list is displayed as shown in FIG. 13, a nurse selects one job from the job schedule list, and executes the selected medical activities in step S24 shown in FIG. 6.

At this time, the nurse who executes the medical activities at the execution site operates his or her portable PDA 8 to input the execution contents of the medical activities. When the inputting process is completed, the execution contents are transmitted to the hospital information management system 2 through the server 7.

In the hospital information management system 2, the medical activities are changed from the job schedule data to the executed medical activities, and the data indicating the execution contents is recorded in the database. When the recording process is completed, the completion notification is returned to the PDA 8.

Thus, the information about medical activities is correctly accumulated in real time in the database of the hospital information management system 2. The information recorded in the database not only contains time information, but is detailed information as described later.

When the completion notification is received, the medical activities displayed in the list on the screen having the “unexecuted” tab 28 in the PDA 8 are defined as executed, and the contents of the job schedule is transferred to the list on the screen having the “executed” tab 29.

Then, control is returned to step S23, one job is selected from the remaining job schedule list, the selected medical activities are executed, and the process of inputting the execution contents is repeated by the nurse, thereby executing all medical activities in the unexecuted job schedule.

Thus, in the present embodiment, a nurse as an executor of medical activities carries the PDA 8 with the nurse so that the job schedule process to be executed by the nurse can be displayed and checked on the display unit 18 of the PDA 8 at any site and time.

In this case, the unexecuted job schedule processes are collectively displayed in the list on the screen having the “unexecuted” tab 28. The nurse executes the processes corresponding to the job schedule of the displayed list at the respective execution sites, and inputs the execution contents, thereby recording the execution contents in the database of the hospital information management system 2. Simultaneously, the display style of the PDA 8 is changed from the list on the screen having the “unexecuted” tab 28 to the list on the screen having the “executed” tab 29. As a result, the nurse can sequentially execute job schedule processes correctly, smoothly, and efficiently by sequentially executing job schedule processes displayed in the list on the screen having the “unexecuted” tab 28 at each execution site.

Thus, since necessary information is set in the job schedule data (XML structured file), medical activities can be executed based on the contents of the job schedule and instruction items when an order is made. Described below are the contents of job schedule data and the data processes performed on the job schedule data when an injection is performed.

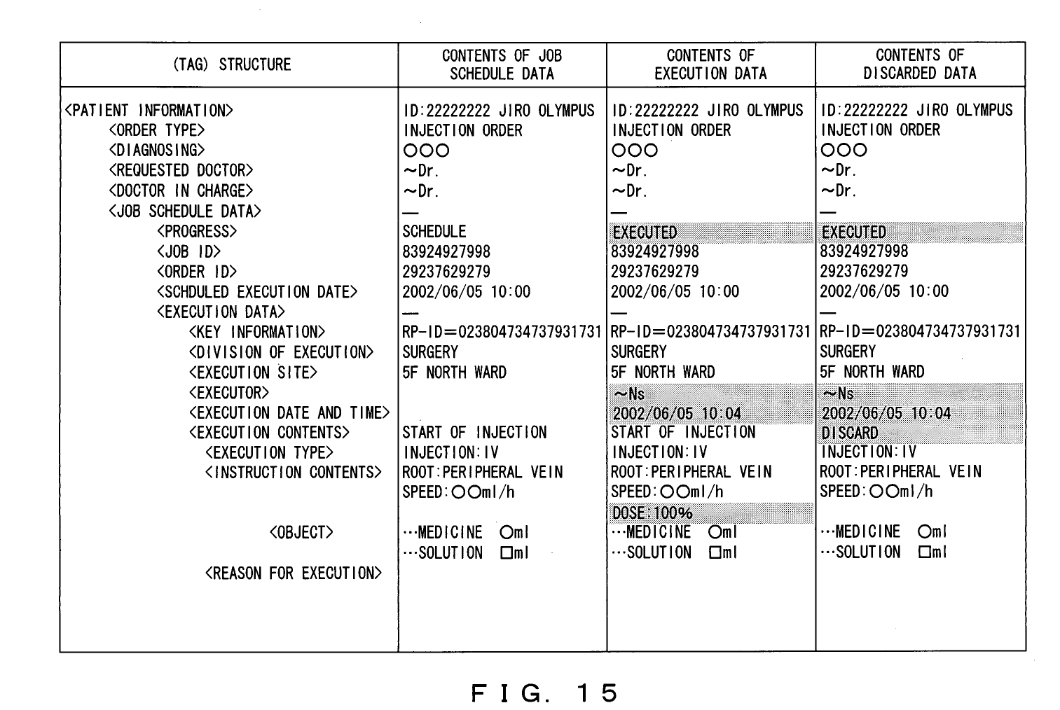

FIG. 15 shows the structure of the job schedule data.

By including the information about “who, where, what, how, and when” required in each process, and acquiring job schedule data, the instruction contents specified when an order is made can be referred to and medical activities can be executed.

When one order is made, a plurality of injections (hereinafter referred to as RP in FIG. 15 for short) can be recorded in a schedule, and the tag data such as <job schedule data>, <execution data>, <instruction contents>, <target>, etc. can be represented as “a plurality of occurrences” (possible repetitive sets).

The “contents of execution data” on the right of FIG. 15 refer to the structure of the execution data recorded from the PDA 8 through the server 7.

The structure is the same as the structure of job schedule data, and includes the information about “who, where, what, how, and when” used in each process. The data not set in the job schedule data such as an executor, an actual execution time, a dose, etc. is set based on the execution contents.

FIG. 15 shows an example on the right. In the column, the shaded area refers to the data added or changed based on the execution contents.

In FIG. 15, the data of the <progress> of the job schedule data is changed from “scheduled” to “executed”, and the data such as <executor>, <execution date and time>, and <dose> is added based on the executed contents of data, and represented as execution data. FIG. 15 shows <executor> as˜Ns for short.

The data structure of discarded data is shown in the rightmost column in FIG. 15, and the shaded area of the contents of job schedule data is changed data. The discarded data is described later.

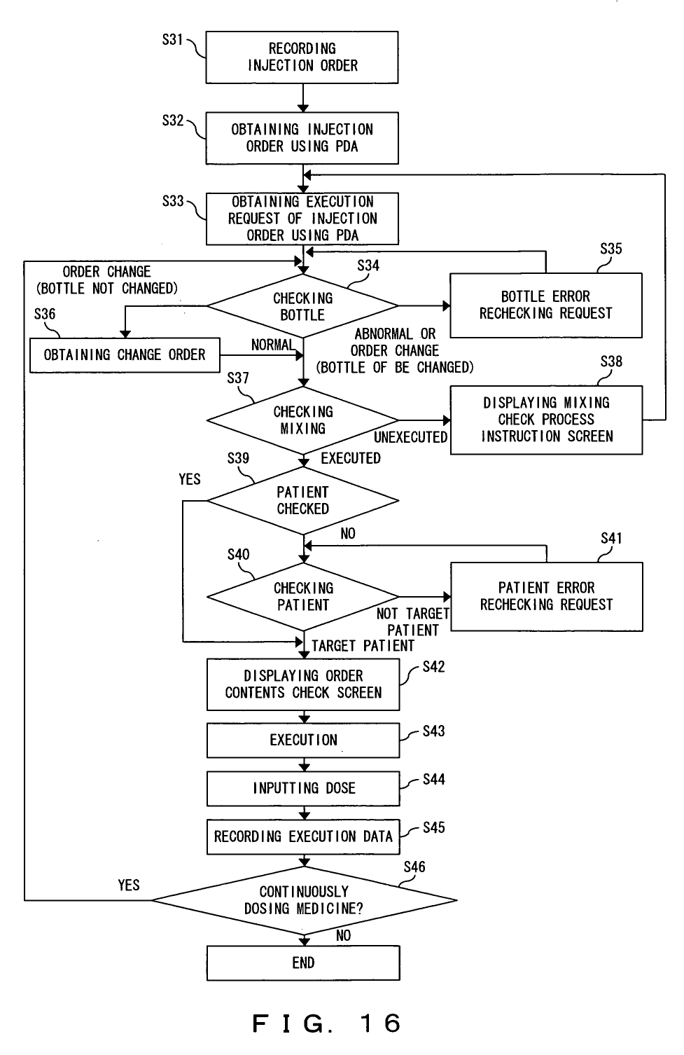

The flowchart shown in FIG. 16 is described below. FIG. 16 is a flowchart of the process of the hospital information system 1 when an injection is performed (dosed).

First, an injection order issued by a doctor in charge of a patient is recorded in the hospital information management system 2 in step S31. In step S32, the job schedule data generated based on the injection order is acquired by the PDA 8.

In step S33, a request to execute an injection order from a nurse is input to the PDA 8, and acquired by the PDA 8.

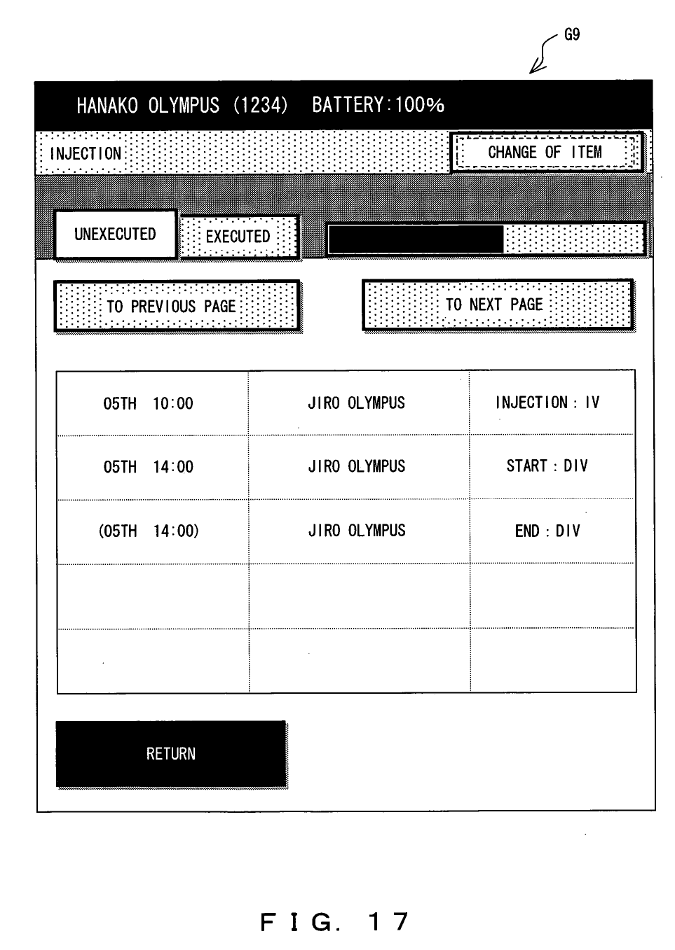

For example, when a nurse inputs selection of the “job list for each item” on the screen shown in FIG. 12 using the PDA 8, the PDA 8 changed to the state of displaying only a job schedule of an injection. FIG. 17 shows the screen G9 displayed on the PDA 8 in the state of displaying only a job schedule about an injection.

On the screen G9, when the schedule of “5th at 10:00, Jiro Olympus, injection: IV” at 10:00 on 5th is considered for example, the information set in the job schedule data is described in the right column shown in FIG. 15.

For example, when the nurse selects a line of “5th at 10:00, Jiro Olympus, injection: IV” on the screen G9, the selection result is acquired by the PDA 8 in step S33 as described above.

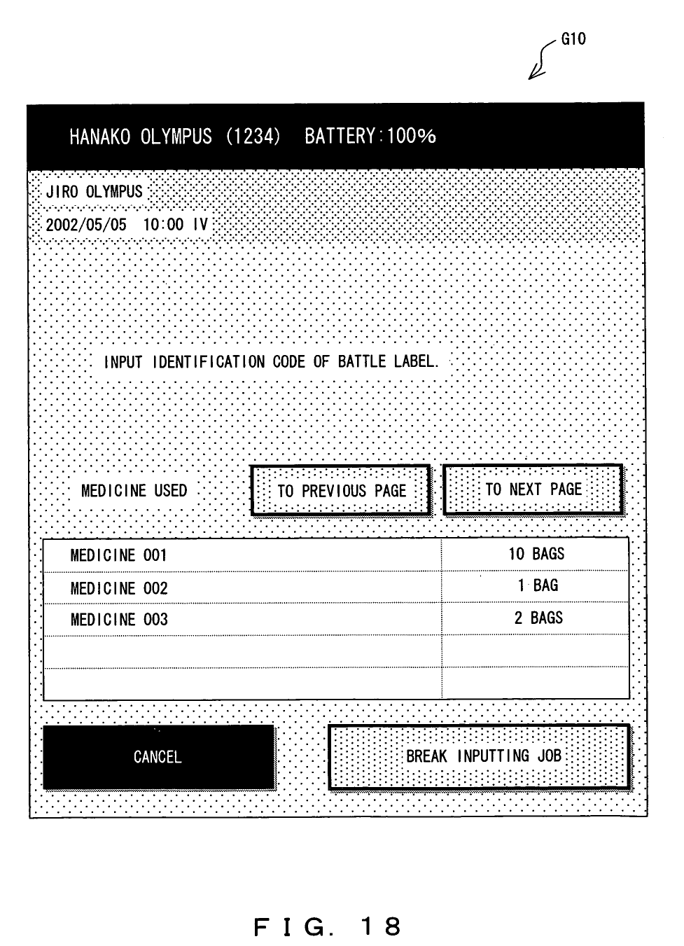

Then, control is passed to step S34 shown in FIG. 16, and a bottle checking process is performed. At this time, the PDA 8 carried by the nurse displays the display screen G10 shown in FIG. 18, and displays a message such as “input the identification code of the bottle label”, etc., and all medicines (medicine name and usage) mixed in the injection bottle are displayed. Since the display space of the PDA 8 is restricted, the display of a prompt to check a bottle and the display of the screen of the contents of an injection order are displayed on the same screen.

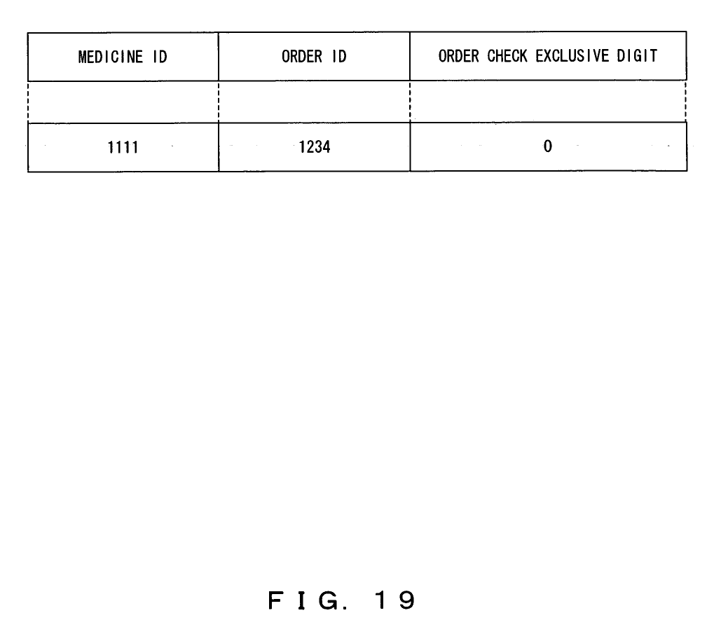

Described below is the format of the identification code of an injection order according to the present embodiment. FIG. 19 shows the format of the identification code of an injection bottle.

In the table, “medicine ID” is information identifying the medicine mixed in an injection bottle.

An “order ID” is identification information designating an “injection order” on which a medicine mixing process is performed.

The “order check exclusive digit” is set to a constant value when it is displayed on a label applied to an injection bottle. In the example able, the value is 0. However, if the injection order specified by the above-mentioned “order ID” has been changed by a doctor in charge of a patient after the mixing process performed with the injection bottle, then the “order check exclusive digit” of the identification code managed corresponding to the injection order in the hospital information management system 2 is changed by increment by 1 each time a change is made.

Assume that the bottle identification code displayed in the above-mentioned table is displayed on the label applied to an injection bottle. In this case, the medicine mixing process on the injection bottle is performed at an instruction indicated in the job schedule data designated by the order ID of “1234” in the injection orders managed in the hospital information management system 2, and it is determined from the bottle identification code that an instruction to mix the medicine designated by the medicine ID of “1111” has been issued.

On the other hand, in the hospital information management system 2, the bottle identification code of the injection bottle managed corresponding to the injection order designated by the order ID of “1234” is “1111, 1234, 0” unless the injection order has been changed. If the injection order has been once changed, and the medicine mixing process has not been changed, then the bottle identification code is “1111, 1234,1”. If there has been a change made to the medicine mixing process, then, for example, “1112, 1234, 1” is set.

In the bottle checking process in step S34 shown in FIG. 16, an order ID matching/non-matching checking process is performed between the bottle identification code displayed on the bottle label applied to the injection bottle and the bottle identification code indicated by the PR-ID of the job schedule data relating to the selection result obtained in the process in step S33. If the process result is “non-matching”, it is determined that the injection bottle is not to be used for the injection order of the execution request of the nurse. Then, in step S35, the PDA 8 give the nurse a warning display and a warning tone, and the process in step S34 is repeated.

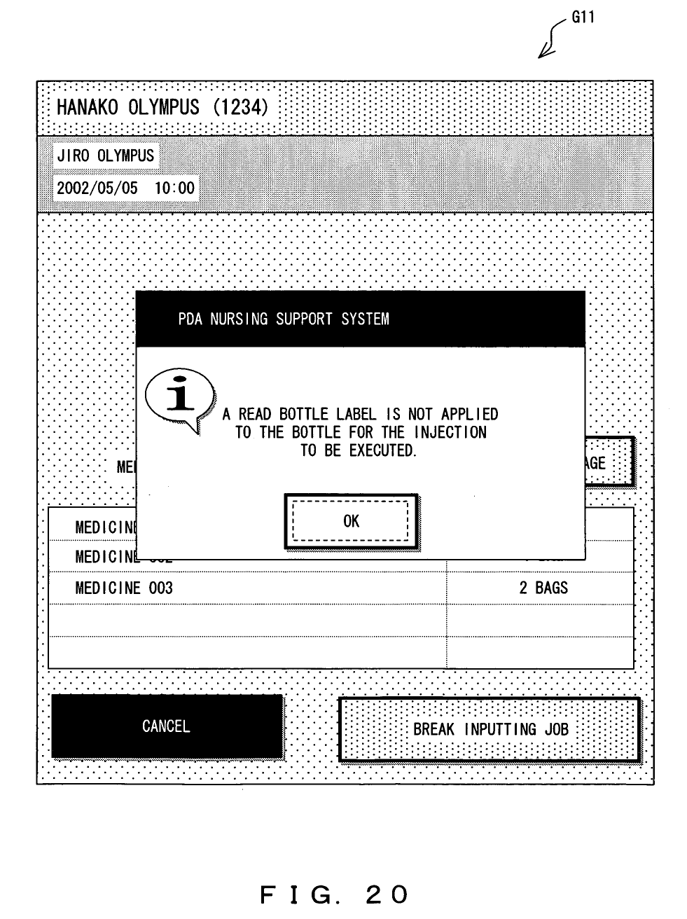

FIG. 20 shows the screen G11 of a warning display, and a warning message such as “a read bottle label is not applied to the bottle for the injection to be executed”, etc. is displayed.

If it is determined in the determining process that the IDs match each other, then a matching/non-matching checking process is performed between the bottle identification code displayed on the label applied to the injection bottle and the identification code of the injection bottle managed corresponding to the injection order in the hospital information management system 2 and designated by the order ID of the identification code. If the result indicates complete matching between the identification codes, then the bottle check result is “normal”, and control is passed to step S37.

If the medicine IDs do not match between the identification codes, the injection bottle can contain mixed medicines. Therefore, it is determined that the bottle cannot be used in executing the injection order, control is passed to step S35 as in the case above, the PDA 8 issues a warning display and a warning tone to notify the nurse of the result, and the process in step S34 is repeated.

If the medicine IDs match but the order check exclusive digits do not match between the identification codes, then it is determined that the injection order to be executed has been changed but injection bottle can be used in executing the injection order although the mixing process has been performed. Then, in step S36, the process of acquiring from the server 7 the job schedule data generated at an injection order issued after the change is performed by the PDA 8.

In the processes in steps S34 to S36, the final check is made as to the presence/absence of a change in injection order, and the nurse can take action to acquire the change contents of an instruction of an injection order depending on the result of the final check. Therefore, an error relating to an injection can be avoided. Additionally, since the above-mentioned format of bottle identification code is used, the presence/absence of a change in an injection order can be checked by a matching/non-matching checking process between the bottle identification code displayed on the label applied to the injection bottle and the identification code of the injection bottle managed corresponding to the injection order in the hospital information management system 2 and designated by the order ID of the identification code.

Then, a mixing checking process is performed in step S37.

In this process, the bottle identification code acquired by the PDA 8 in the bottle checking process in step S34 and displayed on the label applied to the injection bottle is transmitted to the server 7. After receiving the bottle identification code, the server 7 issues an inquiry to the hospital information management system 2, and it is determined whether or not a process of checking whether or not the medicine mixing process has been appropriately performed on the injection bottle relating to the bottle identification code has been performed, that is, whether or not the execution data of the checking process has been recorded in the hospital information management system 2. That is, in this step, the final check of the mixing process before execution of the injection order is performed, and an error of giving a patient a wrong dose of medicine different from an injection order can be avoided.

Afterwards, the determination result is transmitted from the server 7 to the PDA 8.

When a received determination result indicates an executed checking process, the PDA 8 passes control to step S39. When a received determination result indicates an unexecuted checking process, a screen displaying the characters indicating a notification of prompting the execution of a mixing checking process, for example, “a mixing check is unexecuted, and is to be executed”, etc. is displayed on the display screen of the PDA 8. Then, according to a process instruction of the nurse who has checked the notification, the job schedule screen G9 relating to the injection shown in FIG. 17 is displayed, and control is passed to step S33.

Until the above-mentioned determination result is received from the server 7 after the bottle identification code is transmitted to the server 7, the PDA 8 displays the screen displaying the characters indicating “under mixing check”, etc., so that the screen is not displayed when the determination result of an executed checking process is received from the server 7.

In step S39, it is determined whether or not the next step S40, that is, the patient checking process has been performed. Only when the determination result is YES, control is passed to step S42.

The patient checking process is performed in step S40. The process is to determine whether or not the patient relating to the job schedule data of an injection execution request acquired by the PDA 8 in the process in step S33 matches the patient to be dosed with an injection in the execution of an injection by the nurse.

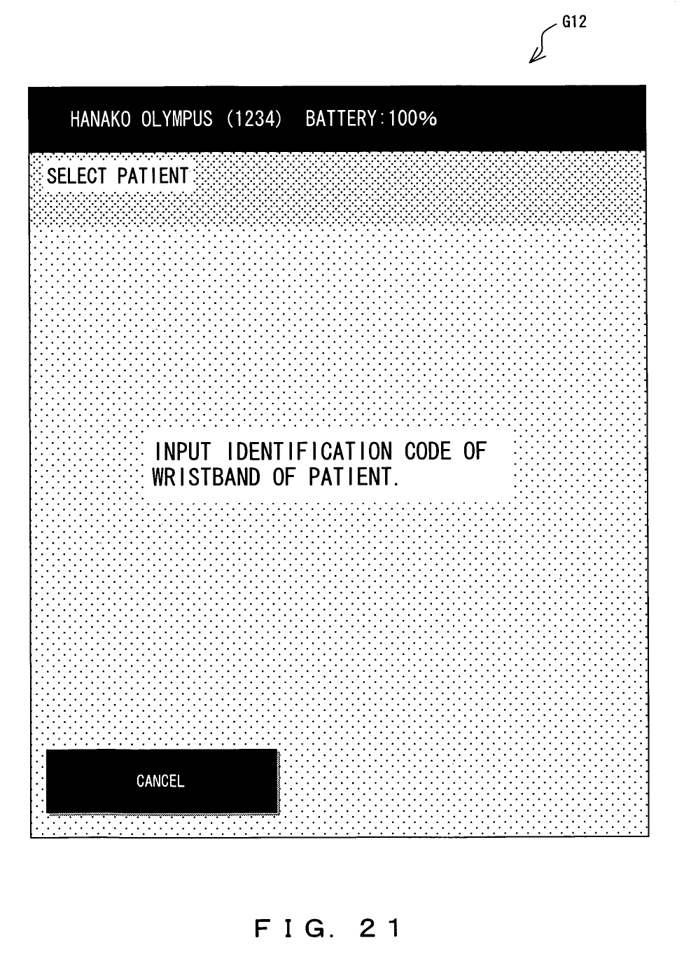

FIG. 21 shows the display screen G12 displayed when a wristband check is made on a patient. In the process in step S39, the display of the PDA 8 is changed to the screen G12. On the screen G12, for example, a message such as “input an identification code of the wristband of the patient”, etc. is displayed.

The nurse reads the identification code of the patient wristband on the patient using the PDA 8, and checks whether or not the patient identification code matches the patient ID in the job schedule data. If it is determined in the matching check that they match each other, control is passed to step S42. If it is determined that they do not match each other, then the PDA 8 displays the screen indicating a wrong patient and an instruction to recheck the patient in step S41. Then, at a process instruction of the nurse indicating that the notification is received, control is returned to step S40, and the display screen G12 is displayed when a wristband check shown in FIG. 21 is made, and the patient checking process is executed again.

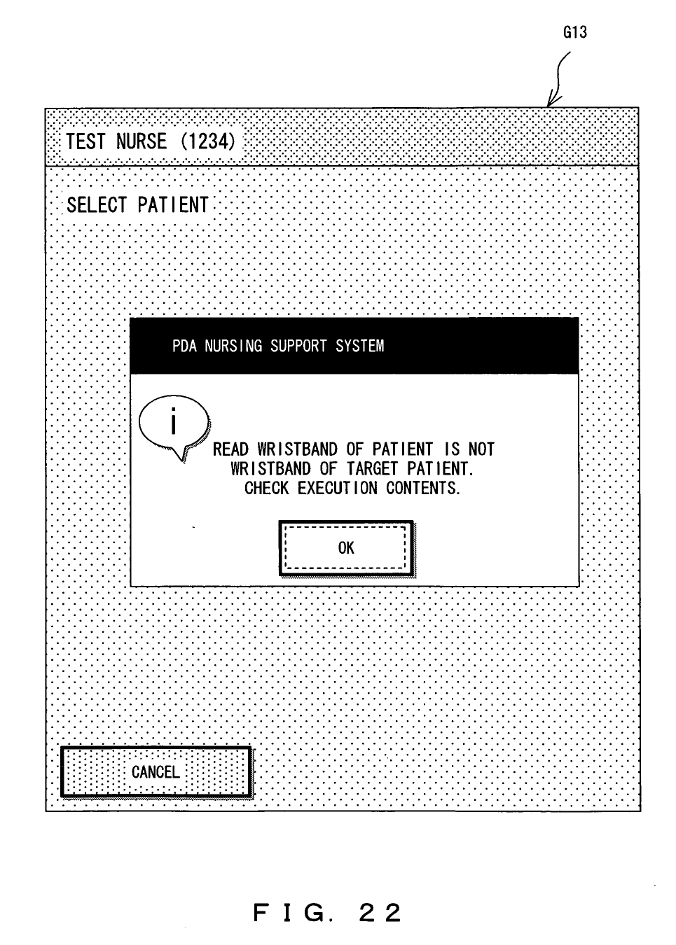

FIG. 22 shows the display screen G13 when a wrong patient is announced, and a warning message such as “read wristband of patient is not a wristband of target patient. Check execution contents”, etc. is displayed.

Thus, when a wrong patient is selected, the identification code of the wristband does not match the patient ID. Therefore, the error is detected, and a warning display and a warning tone are issued for notification.

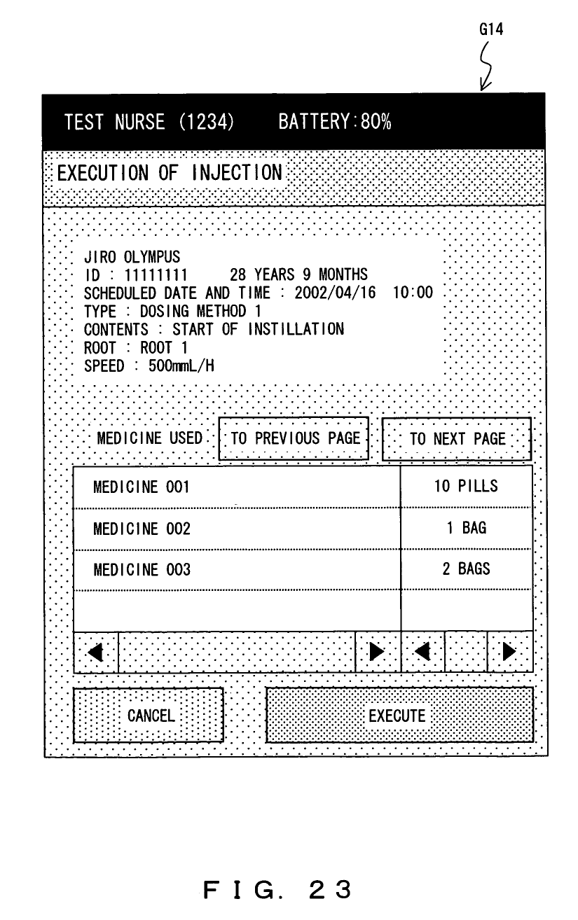

When a patient check is made in step S40, control is passed to step S42, and a process of displaying order contents is performed. In this case, the PDA 8 displays an injection execution determination screen G14 shown in FIG. 23.

On the screen G14, the instruction contents recognized when an injection order is made are displayed. That is, since patient information, a scheduled date and time, the type/contents/root (where the injection is dosed)/speed of injection, information about mixed medicines, etc. are displayed, a nurse can make a final check of the instruction of an injection order, and an error relating to an injection can be avoided.

When the instruction contents of the order are checked, the injection order is executed in step S43.

After the execution of the injection in step S43, a process of inputting a dose of injection in the execution of the injection is performed in step S44.

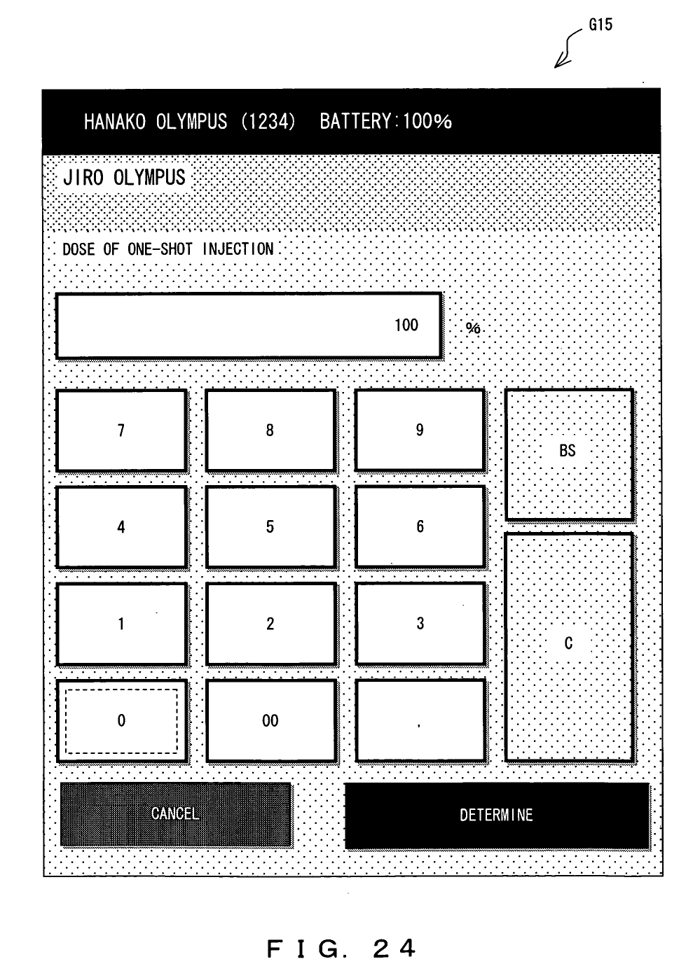

FIG. 24 shows the screen G15 on which the dose is input on the PDA 8.

The screen G15 is a screen similar to the input unit of a calculator on which the percentage of a medicine can be input (the default is 100%, and the determination can be pressed if no change is required).

By inputting the dose, the execution data is entered in step S45, and is recorded in the hospital information management system 2 from the PDA 8 through the server 7.

When an injection is applied, all injection in the bottle may not be dosed as necessary. Therefore, the precise amount of dose can be recorded. Depending on the change of the condition of a patient, an instruction issued when an order is made, etc., only 50% or 70% of the injection can be dosed. Furthermore, data is input in a % unit, but can also be input in a milliliter unit and so on, depending on the available container.

In step S46, it is determined whether or not there is a job schedule continuously performed by an injection using another medicine on the patient the injection was dosed in step S43. If the determination result is YES, control is returned to step S34, and the above-mentioned process is repeated. If the determination result is NO, the flowchart of the process terminates.

When the process from S34 is repeated after S46, the determination result in step S39 is YES because the patient checking process in step S40 has already been performed. As a result, the patient checking process is not required again, and the job efficiency can be improved when an injection order is executed.

In the flowchart of the process shown in FIG. 16, the injection bottle is checked first in the processes in steps S34 through S37, and the patient check is performed in the processes in steps S40 and S41 so that the patient check cannot be repeated although a problem is detected by checking the injection bottle. Thus, the job efficiency can be improved when the injection order is executed, and the unpleasantness of the patient given by repeating the read of the patient identification code displayed on the wristband of the patient can be removed.

This method is especially effective in performing a one-shot injection. However, since a long time is required to finish an instillation, both “start of injection” and “end of injection” are input unlike the case of a one-shot injection.

When a one-shot injection is performed, the job is performed in the following order.
(1) bottle label check→(2) wristband check→(3) dosing→(4) end of injection and input of dose

However, when an instillation is performed, the job schedule is executed as follows.

(Start of Instillation)
(1) bottle label check→(2) wristband check→(3) start of injection

(End of Instillation)
(1) bottle label check→(2) end of dose (extraction of needle)→(3) end of injection and input of dose

The explanation is given with job schedule data. That is, in the case of a one-shot injection, the job schedule data of “start of injection” and the job schedule data of “end of injection” are simultaneously recorded. However, in the case of an instillation, “start of injection” (“start of instillation”) and “end of injection” (“end of instillation”) are recorded at the respective timings.

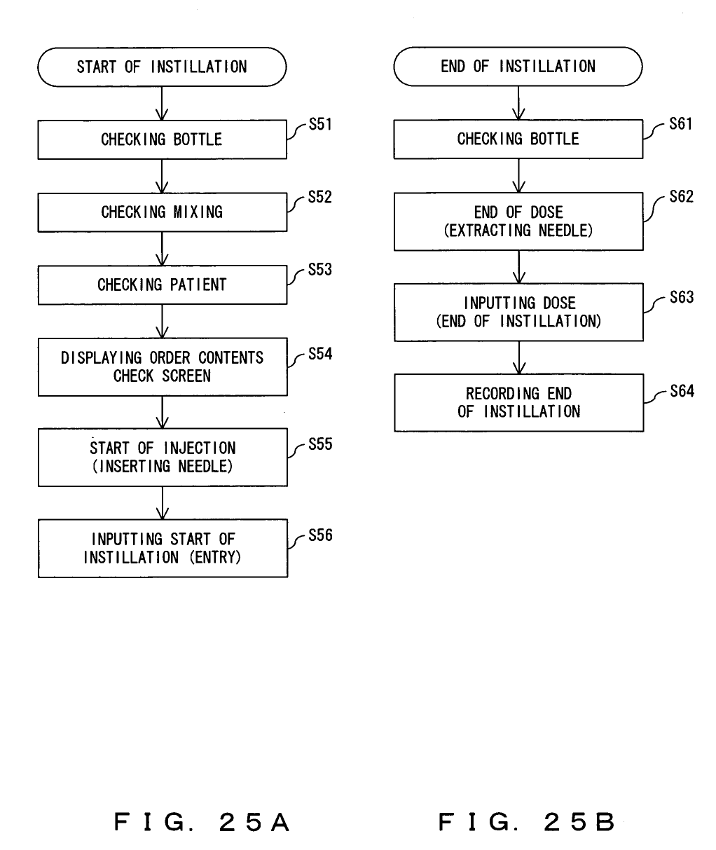

FIGS. 25A and 25B show the process contents indicated when the medical activities of an instillation are performed. FIG. 25A shows the process contents of the start of instillation, and FIG. 25B shows the process contents of the end of instillation.

As shown in FIG. 25A, at the start of instillation, the bottle check process is performed in step S51. The bottle check (as in the mixing check and the patient check described below) is practically carried out by returning to step S51 after giving a warning of the check result of NG indicating abnormality. However, for simple explanation, the process is described below by assuming that an appropriate bottle is used.

When the result of a bottle check is accepted, control is passed to step S52 of the mixing check process. If the result of the mixing check is accepted, control is passed to step S53 of the patient checking process. If the result of the patient checking process is accepted, control is passed to step S54 of the process displayed on the order contents check screen.

After the process of displaying the order contents check screen, control is passed to step S55 of start of injection (insertion of needle) That is, the needle of the instillation is inserted to the patient who is checked on the patient identification code on the wristband, and the medical activity of dosing a set medicine is started. The nurse who starts the activity simultaneously (at the same timing) inputs the start of instillation on the PDA 8 in step S56. The PDA 8 returns the information to the hospital information management system 2, and the execution data of the start of instillation is recorded in the database of the hospital information management system 2. Dosing the scheduled medicine is started for the patient by the instillation.

When the dosing of the medicine by the instillation is completed, the nurse who performs the medical activity of the end-of-instillation job makes a bottle check in step S61 shown in FIG. 25B by operating the PDA 8, and then extracts the needle of the instillation in step S62, thereby performing the end-of-dosing job (extraction of needle), and inputs the display on the PDA 8 in step S63, thereby performing the end-of-instillation job.

By inputting the dose, the information about the end-of-instillation job is returned from the PDA 8 to the hospital information management system 2, and the execution data of the end-of-instillation job is recorded in the database of the hospital information management system 2 in step S64.

Thus, even in the case of the medical activities requiring a time-consuming process, the detailed information can be recorded in the database of the hospital information management system 2 correctly at the start of the medical activities, and the detailed information can also be recorded when the medical activities terminate. Thus, the more appropriate support can be realized as follows.

For example, when a start-of-instillation job cannot be started on the scheduled job time of the start of instillation, the scheduled time of the end of instillation is necessarily changed. The hospital information management system 2 refers to the time of the actual start-of-instillation job, and changes the scheduled time of the job for the end-of-instillation job in the database.

With the change, when the nurse having the job schedule data of the end-of-instillation job downloads the job schedule data from the database of the hospital information management system 2 using the PDA 8 and refers to and browses the obtained data as the job schedule data, the nurse sees the scheduled job time for the end-of-instillation job has been changed. Therefore, the nurse can immediately accept the change of the job.

In the above-mentioned case, there can often be the case in which the nurse who performed the start-of-instillation job also performs the end-of-instillation job, and the nurse can correctly know the scheduled time of the end-of-instillation job. As a result, the nurse can easily adjust the job schedule after the changed job.

If it takes a long time to dose a medicine from the start of instillation to the end of instillation and it is not necessary for the nurse to attend the instillation at the execution site, the nurse can efficiently execute other job schedules during the instillation. Also in this case, since the scheduled time of the end-of-instillation job can be more correctly acquired, the nurse can easily execute other job schedules.

When the necessary who actually performs the start-of-instillation job performs the start-of-instillation job around the end of the working hours and asks another nurse to take over the end-of-instillation job according to the job schedule, the other nurse can access the database using the PDA 8 and refer to or browse the job schedule data, thereby quickly knowing that the time of the start-of-instillation job is delayed and the scheduled time of the end-of-instillation job is also delayed, and easily accept the change of the entire schedule.

For example, by performing other scheduled medical activities in the period available due to the delayed job, the influence on the subsequently scheduled jobs can be reduced, thereby smoothly executing the entire schedule of medical activities.

Thus, although a scheduled job cannot be actually started at a scheduled time and delayed in the medical activities requiring a time-consuming process, it is immediately announced to the nurse. Therefore, the subsequent medical activities can be performed with a smaller influence of the delay and smoothly performed.

Furthermore, by analyzing the information in detail from the database, the cause of the delayed medical activities can be checked and improvements can be expected later in generating schedules.

That is, in the above-mentioned case, not only the time, but also the information about “who, where, what, how, when” can be recorded in detail in the database when an instillation starts and ends. Therefore, sufficient information can be provided for a later analysis, and the analysis can be carried out in detail.

For example, the information recorded when an instillation is started and finished includes the data of the execution date and time, an executor, an execution site, execution contents, and a related patient, etc. The data corresponds to what is displayed in the column of the contents of the execution data shown in FIG. 15. FIG. 15 shows the outline of the result of the execution of the job using the job schedule data or the discard of the job schedule. In FIG. 15, a one-shot injection (the time of the start of the activity is almost the same as the time of the end of the activity) is described for simple explanation of the outline of the execution.

Therefore, when the start-of-instillation job is executed when a time-consuming injection is performed, the <progress> data is defined as “executed” (“the start-of-instillation job has been executed” in more detail) in the execution data from “schedule” in the job schedule data, and the “dose” shaded in FIG. 15 in the execution data column is not input for the <instruction contents>data. The shaded “dose” is performed by executing the end-of-instillation job.

When the execution data of the start-of-instillation job is recorded, the hospital information management system 2 changes the data of the <execution scheduled date and time> in the column of the contents of the job schedule data of the end of instillation as a pair to the start of instillation to the date and time of the execution data of the start of instillation, thereby generating a more correct database, and providing a user who references the data with more correct information.

Thus, since information is recorded in detail, the system can be used to grasp the capability and the load of performing a job of each nurse who performs medical activities in addition to the analysis for improvements of the program of the entire system.

In the explanation above, correct information is recorded and accumulated in the database. However, when a time-consuming medical activity such as an instillation from start to end is perform, the CPU (not shown in the attached drawings) of the hospital information management system 2 determines whether or not a delayed time exceeds a predetermined time when the information about the actual starting time is recorded based on the scheduled starting time. If it determines that the delayed time exceeds the predetermined time, the executor who performs the end-of-instillation job can be informed on his or her PDA 8 that the job schedule of the end-of-instillation job bas been changed.

In the informing process, the executor can easily understand the change of the scheduled time of the end-of-instillation job. However, it is not limited to this application, and a message of acquiring the latest job schedule data can be used. Such a message can be used in other situations, and the program can be simplified.

When an executor who performs the start-of-instillation job is different from an executor who performs the end-of-instillation job, the mailing capability of the PDA 8 can be used to inform the executor who performs the end-of-instillation job from the executor who performs the start-of-instillation job that the scheduled time of the end-of-instillation job is delayed because the time of starting the instillation is delayed.

In the explanation above, the time-consuming medical activity is to apply an instillation, but other medical activities, for example, a medical activity of acquiring an electrocardiogram, etc. can be also processed similarly.

Described below is the process of unscheduled medical activities as another embodiment of the present invention. Unscheduled medical activities are taken unexpectedly or in an emergency, and include a job of urgently inputting a result of measurement of vitals, etc. and inputting a break such as a broken bottle, etc.

Inputting the data of vitals refers to a job of inputting a measurement of a temperature, pulse, aspiration, blood pressure, etc. For example, the measurement of vitals taken at 6:00, 10:00, and 12:00 is executed as a job order of scheduled normal vital measurement at an instruction input by a doctor to the server 7 in advance. Additionally, there can be the case in which the vital measurement has to be performed unexpectedly or in an emergency according to, for example, a sudden change in condition of a patient, an oral instruction of a doctor or a chief nurse, a request from a patient, etc. It is hereinafter referred to as an unscheduled inputting job.

When there is a break detected in an injection bottle for any reason in a hospital room during the mixing process, data has to be input about the break. This is hereinafter referred to as a break inputting job.

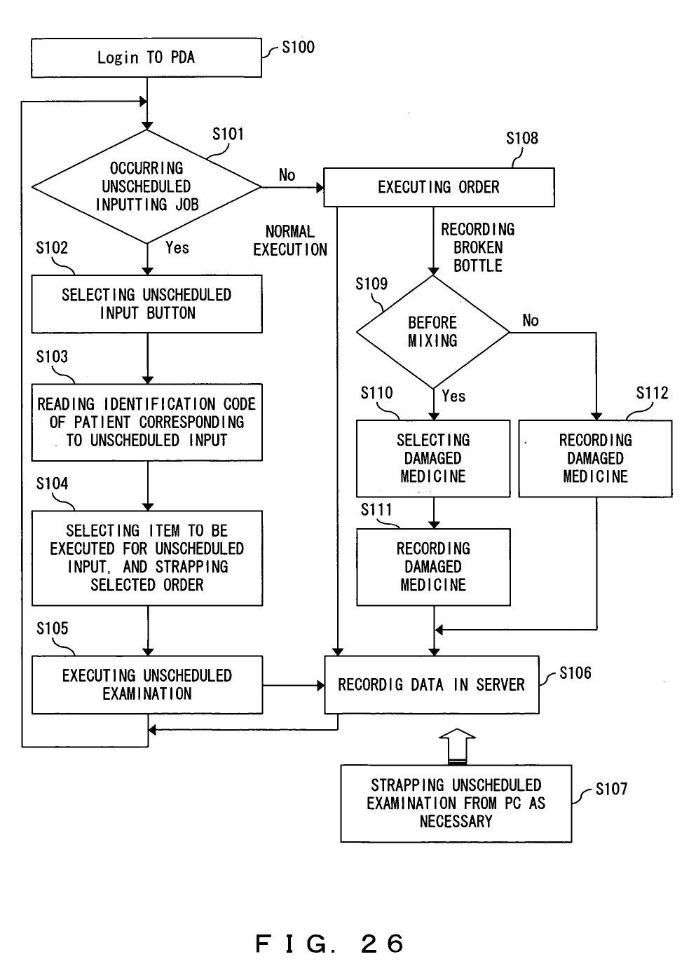

FIG. 26 is a flowchart of the process contents collectively showing the unscheduled medical jobs such as the above-mentioned unscheduled inputting job, break inputting job, etc. and the medical execution jobs based on the normal orders described above. The process procedure is also treated in the communications between the server 7 of the PDA system 4B shown in FIG. 1 and the PDA 8 shown in FIGS. 1 and 2.

In FIG. 26, a user first logs into the PDA 8 (step S100).

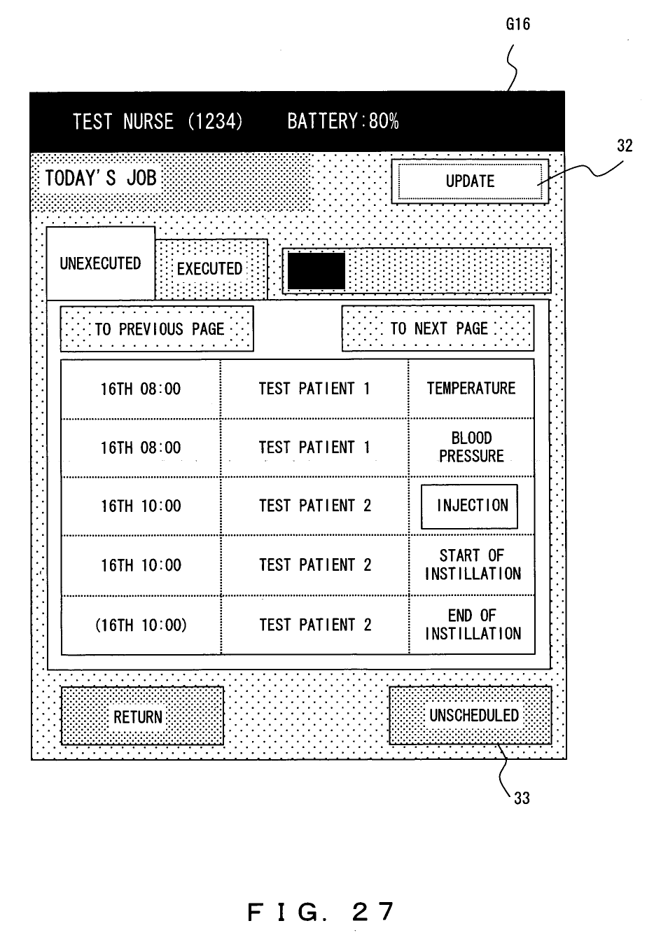

FIG. 27 shows the medical execution schedule screen of normally scheduled job to be executed in the today's working hours displayed on the display screen of the PDA 8 during the above-mentioned login. The execution schedule screen G16 is configured in almost the same display format as the execution schedule screen G9 shown in FIG. 17, but shows a little different display in the present embodiment.

On the execution schedule screen G16 according to the present embodiment, the name of an executor and the remaining time of a built-in rechargeable battery on the top display column are a “test nurse (1234)” which is the name of the nurse corresponding to the ID recorded in the PDA 8 when the PDA 8 is picked up from the storage area of the PDA 8 at the start of the working hours, and a remaining time of a rechargeable battery of “battery: 80%” as on the execution job schedule screen G9 shown in FIG. 17. Below the column, “today's job” is displayed instead of the name of the execution joy, to the right of which an update button 32 is displayed for the item change button. According to the present embodiment, a unscheduled button 33 is added to the right of the return button on the left of the button display area of the bottom portion of the screen to receive an unscheduled input.

On the execution schedule screen G16, the latest medical execution data is displayed in the medical execution instruction column at the center when the update button 32 is pressed immediately after the login. In the medical execution instruction column, the measurements of the temperature and the blood pressure as the execution scheduled job at 8:00 and the execution instruction of an instillation as the execution scheduled job at 10:00 of the day 16th are displayed.

At this time, it is determined whether or not an unscheduled inputting job has occurred (step The determination is made on the test nurse (1234). If the test nurse (1234) is to execute a medical activity of unscheduled vital measurement due to a sudden change of the condition of a patient or at an oral instruction of a doctor or a chief nurse or a request of a patient, then it is determined that the test nurse (1234) has to perform an unscheduled inputting job (YES in step S101).

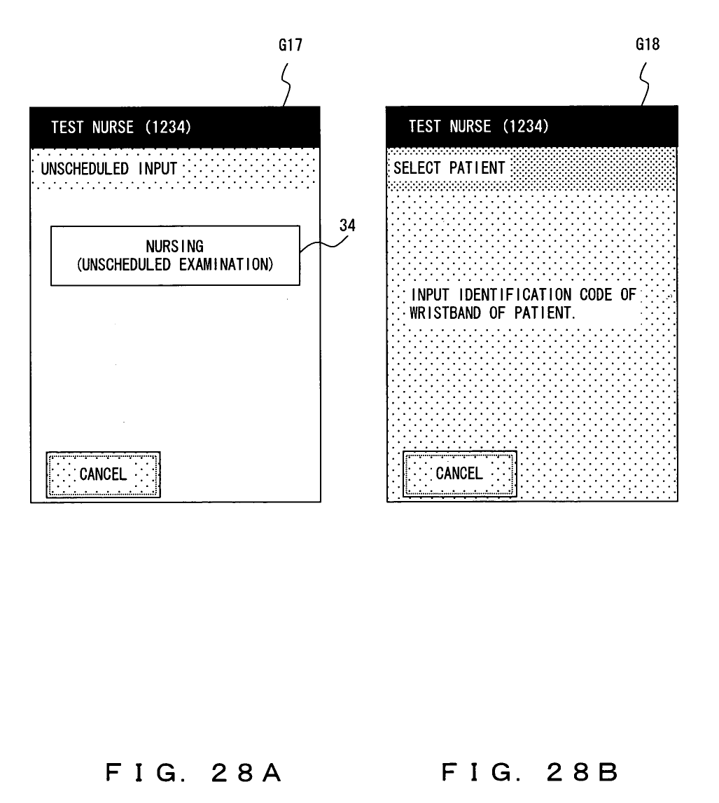

In this case, the processes in steps S102 through S107 are performed. In the process procedure of steps S102 through S107 described below, the execution schedule screen G16 shown in FIG. 27 is followed by an unscheduled input screen G17, a patient selection screen G18, a measurement item selection screen G19, a selection item check screen G20, an order strap selection screen G21, a temperature data input screen G22, a pulse data input screen G23, and blood pressure data input screens G24a and G24b respectively shown in FIGS. 28A, 28B, 29A, 29B, 30, 31A, 31B, and 31C sequentially on the display unit 18 of the PDA 8.

First, on the execution schedule screen G16 shown in FIG. 27, the unscheduled button 33 is selected and touched (step S102).

Then, the unscheduled input screen G17 shown in FIG. 28A is displayed on the display unit 18 of the PDA 8. The unscheduled input screen G17 is a selection input screen of an unscheduled job. In the example shown in FIG. 28A, except the top display portion of an executor and a remaining time of a built-in rechargeable battery (hereinafter the display of the remaining time of a rechargeable battery is omitted), the lower display portions are changed into the screen for unscheduled inputs. That is, immediately below the top executor name display portion, the “unscheduled input” is displayed, and a nursing (unscheduled examination) button 34 is displayed in a somewhat upper position in the lower and larger display portion.

FIG. 28A only shows the “nursing (unscheduled examination)” indicating the measurement of vitals, etc. as an unscheduled examination in the unscheduled job, but actually a selection button is displayed for the “treatment” and other unscheduled jobs. However, in FIG. 28A, the “unscheduled examination” is displayed as a representative example.

First, the identification code of a patient who executes an unscheduled input is read (step S103).

In this process, when the nursing (unscheduled examination) button 34 of the unscheduled input screen G17 is pressed, the display screen is switched to the patient selection screen G18 shown in FIG. 28B.

On the patient selection screen G18, the “selection of patient” is displayed immediately below the top executor name display portion, and the lower and larger display portion is displayed in a different background color. In the center of the larger portion, an instruction message “input identification code of wristband of patient” is displayed. Thus, the display of the PDA 8 directs the nurse to read the identification code from the wristband of the patient. The identification code read screen G18 shown in FIG. 28B is the same screen as the wristband check screen G12 shown in FIG. 21.

The identification code of the wristband of the patient is read by the identification code reader provided for the PDA 8. When the identification code is read by the PDA 8, an execution item for unscheduled input is selected, and an order strapping process is performed on the selected execution item (step S104).

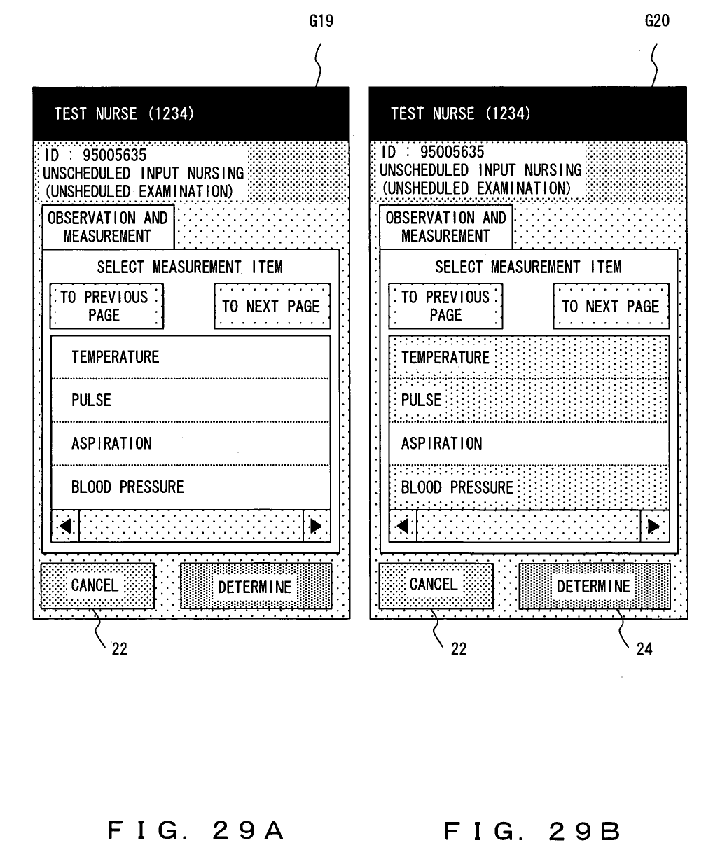

In this process, the measurement item selection screen G19 shown in FIG. 29A is displayed on the display unit 18 of the PDA 8. On the measurement item selection screen G19, the read ID of the patient is displayed as “ID: 95005635” immediately below the top executor name display portion. Below the top portion, the characters “unscheduled input: nursing (unscheduled examination)” indicating that the unscheduled input refers to the nursing (unscheduled examination) Below the portion, two stage column is displayed. The upper portion displays the medical execution contents “observation and measurement”. The lower portion displays an input instruction “input select measurement item”.

The measurement items for input of selected items of a temperature, pulse, aspiration, and blood pressure are displayed in four lines. The test nurse (1234) sequentially touches the respective indicators and selects the items to be measured in the unscheduled examination, for example, the temperature, pulse, and blood pressure.

Then, as shown in FIG. 29B, the different background colors of the indicator lines of the selection items are sequentially displayed on the selection item check screen G20. Thus, on the selection item check screen G20, a selection item is displayed such that it can be easily checked visually. If a wrong selection item button is pressed, the indicator line of the wrong selection item can be retouched to recover the background colors and cancel the wrong selection.

If the input measurement data of an unscheduled examination is not associated with an order, the data of the date and the purpose of the execution is not recorded, and therefore is not useful to medical activities. Therefore, the hospital information system 1 associates unscheduled examination data with an order.

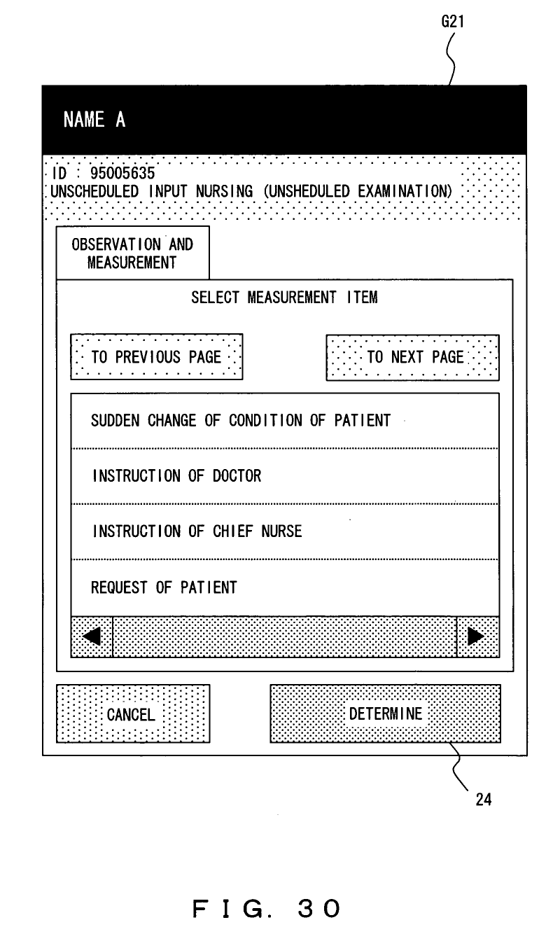

That is, if an item is selected on the measurement item selection screen G19, and the selection item is checked on the selection item check screen G20, and the determination button 24 is pressed by the test nurse (1234), then the order strap selection screen G21 shown in FIG. 30 is displayed on the display unit 18 of the PDA 8.

On the order strap selection screen G21, the display of the top executor name display portion on the measurement item selection screen G19 and the selection item check screen G20 and the display of the selection item line for measurement are changed. The top executor name display portion is changed into a display of a patient name, that is, the patient “A” in this case, and the selection item for measurement is changed into a display of an strapping order name, that is, four order names “sudden change of patient condition”, “doctor instruction”, “chief nurse instruction”, and “patient request”.

If the unscheduled examination is carried out due to a sudden change of the condition of the patient “A”, then the test nurse (1234) selects the selection item “sudden change of patient condition”, and presses the determination button 24, thereby starting the execution of an unscheduled examination (step S105).

In the execution of the unscheduled examination, the screen display method is different from the method in the normal examination. That is, in the case of the normal examination, a temperature is measured, the measured temporary is input, and the determination button 24 is pressed. Then, control is returned to the first screen (the execution schedule screen G16 shown in FIG. 27), and the completed temperature check line is turned off. Therefore, the check of the next line (changed into the top line on the screen display) is made, thereby repeating the process.

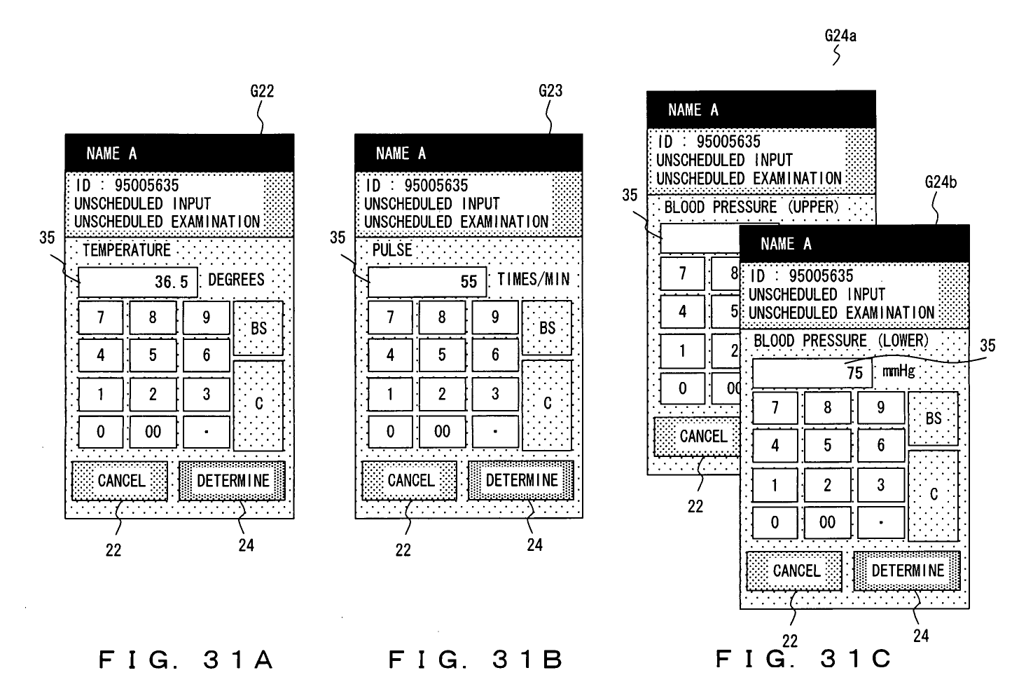

However, in the unscheduled examination, the check of a selection item can be repeated. That is, according to the measurement item checked and determined on the selection item check screen G20, the pulse data input screen G23, and the blood pressure data input screens G24a and G24b shown in FIGS. 31B and 31C are continuously displayed sequentially by an input of measurement data from the temperature data input screen G22 shown in FIG. 31A which is the temperature data input screen selected first as described above.

On the data input screens, only the central display area display is changed excluding the upper two-stage display area and the lower button display area of the order strap selection screen G21. The central display area displays the “temperature” on the top portion on the temperature data input screen G22, and the “degrees” are displayed on the right of the lower input data display portion 35, and the calculator type input processing buttons are displayed in the remaining area.

In the example shown in FIG. 31A, the input data display portion 35 displays the temperature data “36.5” input using the calculator type input processing buttons as the result of the measurement by the test nurse (1234) on the patient “A”.

In the case of the pulse data input screen G23, the “pulse” is displayed in the top portion, the -“times/minute” is displayed on the right of the input data display portion 35, and the display of the calculator type input processing button is continuously displayed in the remaining area.

In the example shown in FIG. 31C, the input data display portion 35 displays the pulse data “55” input using the calculator type input processing buttons as a result of measuring the pulse of the patient “A” by the test nurse (1234).

In the case of the blood pressure data input screen G24a, the top portion displays the “blood pressure (upper)”. In the case of the blood pressure data input screen G24b, the top portion displays the “blood pressure (lower)”. On the right of the lower input data display portion 35, the “mmHg” is displayed, and the display of the calculator type input processing buttons are continuously displayed in the remaining area.

In the example shown in FIG. 31C, the input data display portion 35 displays the blood pressure (upper) of “120” and the blood pressure (lower) of “75” as a result of measuring the blood pressure of the patient “A” by the test nurse (1234).

When the input of the blood pressure data of “75” to the input data display portion 35 is completed based on the blood pressure data input screen G24b which is the final data input screen of these data input screens, the test nurse (1234) presses the determination button 24, thereby starting the data entry in the server (step S106).

In the process of data entry in the server, the data indicating the nursing (unscheduled examination), the data indicating the identification code of the wristband of a patient, the data indicating the selected item for measurement, and the data indicating the order to be associated with the nursing (unscheduled examination) sequentially input from the unscheduled input screen G17 are output from the PDA 8 to the server 7, and stored in a predetermined storage area of the server 7. The data is transferred from the server 7 to the hospital information management system 2, and stored in a predetermined database of the hospital information management system 2.

It is also possible to later perform the order strapping input of the unscheduled examination on the order strap selection screen G21 shown in FIG. 30, immediately execute the measuring job, and perform the order strapping input of the unscheduled examination from the PC terminal 6 of the first subsystem 4A as necessary after completing the data entry (in this case, a provisional entry) in the server in step S106 (step S107).

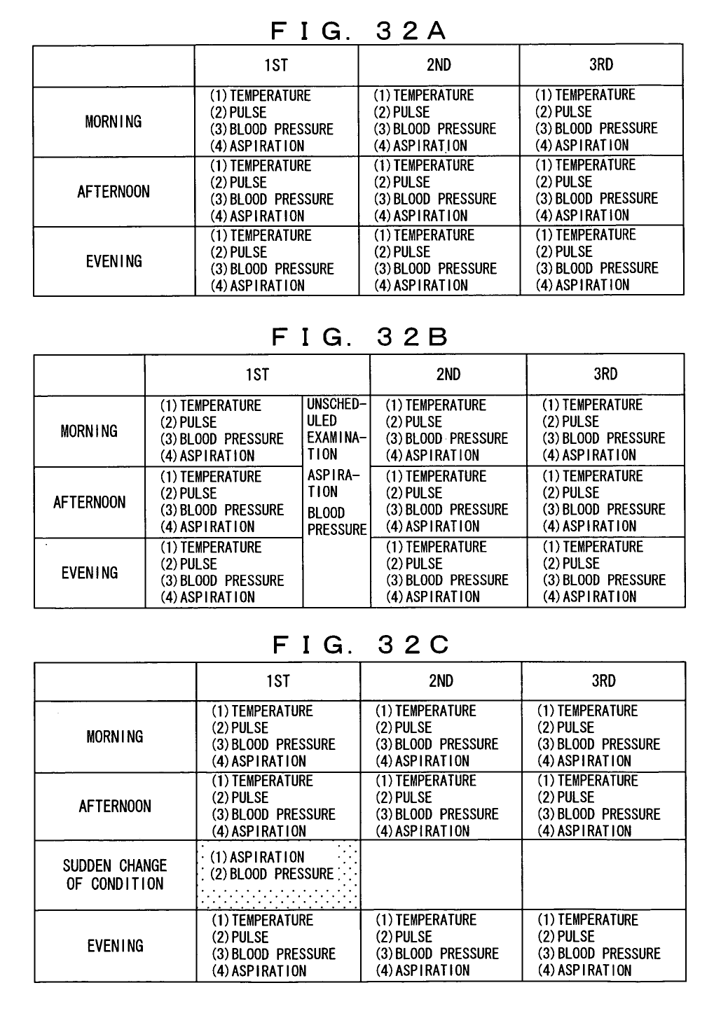

FIGS. 32A, 32B, and 32C show examples of the configuration of the data entered in the later order strapping of the vital measurement data of the unscheduled examination to the normally scheduled vital measurement data.

First, FIG. 32A shows the normally scheduled nursing order of the patient A. As shown in FIG. 32A, the data of the nursing order of the patient A is vertically divided into three rows for morning, afternoon, and evening, and into three columns for the first day, the second day, and the third day. Thus, FIG. 32A shows three orders per day for a total of three days. One order contains four types of vital measurement, that is, <1> temperature, <2> pulse, <3> blood pressure, and <4> aspiration, and the measurement data is entered as the data in the data file of the database of the hospital information system 1. Thus, an instruction of the order information is issued three times a day for a total of three days.

On the other hand, when an unscheduled examination is required, an additional entry of the unscheduled examination data can be made by pressing the unscheduled button 33 on the execution schedule screen G16 shown in FIG. 27 from the terminal of the PDA 8 as described above.

For example, if unscheduled inputs of aspiration and a blood pressure are executed in the afternoon of the first day, an item is selected by selecting an unscheduled input item, aspiration and a blood pressure are measured, and the unscheduled input of the measurement data is performed, then the input value is recorded as data in the database.

FIG. 32B shows the data contents of the data file when the unscheduled examination is performed on the first day. However, FIG. 32B shows the case in which an unscheduled examination is input without association of an order. In this case, as shown in FIG. 32B, data of an unscheduled examination, aspiration, a blood pressure is temporarily recorded between the first day and the second day simply.

In any case, when the unscheduled examination is executed as mentioned above and the unscheduled input is executed, the input value is recorded in the data file of the database of the hospital information system 1, and the unscheduled examination input value is recorded as data together with the data of the normally scheduled nursing order.

As described above, unless the input of the measurement data of the unscheduled examination is associated with the corresponding order, the execution date and time and the purpose of the unscheduled examination are not recorded, and is not useful to medical activities. Therefore, in the case mentioned above, the unscheduled examination is to be associated with a corresponding order.

If the data file shown in FIG. 32B is opened by the PC terminal 6 of the first subsystem 4A, an input screen of the same format as the order strap selection screen G20 is overlaid, and the above-mentioned unscheduled examination input value is associated with the order by selecting and inputting the item of “sudden change of patient condition”, then a new data line is generated in the column of the first day in the time period between the afternoon and the evening when the unscheduled examination is executed, the “aspiration” data and the “blood pressure” data of the unscheduled examination input value are recorded in the data area corresponding to the first day of the data line, and the “sudden change of patient condition” is recorded as the name of the order (cause) in the data area corresponding to the column indicating the time period as shown in FIG. 32C.

Thus, the unscheduled examination input value temporarily recorded in FIG. 32B simply between the first and second days is associated as clear data of a medical environment of the time period in which the unscheduled examination is executed and the name of an order in which the unscheduled examination is executed, and then recorded in the database. Thus, the date and time and the purpose of the execution of the unscheduled examination are clearly recorded, and the fluctuation of the result value can be described in more detail when a measurement result is referred to.

Furthermore, the later association with the unscheduled examination as described above is used not only when the unscheduled examination is performed in an emergency, but also when the detailed contents not entered on the PDA 8 are to be added.

The unscheduled button 33 on the screen G16 shown in FIG. 27 can be similarly displayed on the screen shown in FIGS. 8, 12, 13, and 17, so as to be possible unscheduled input on each screen.

The input of normal medical execution data exclusive of unscheduled examination data is performed based on the order recorded in advance in the hospital information management system 2. In the case of normally scheduled medical execution, when a doctor is too busy to have no time to use the PC terminal 6 and record an order in the hospital information management system 2 in advance, the order can be orally indicated to a nurse. In this case, in the hospital information system 1 according to the present embodiment, the medical execution data can be input at the order using the PDA 8.

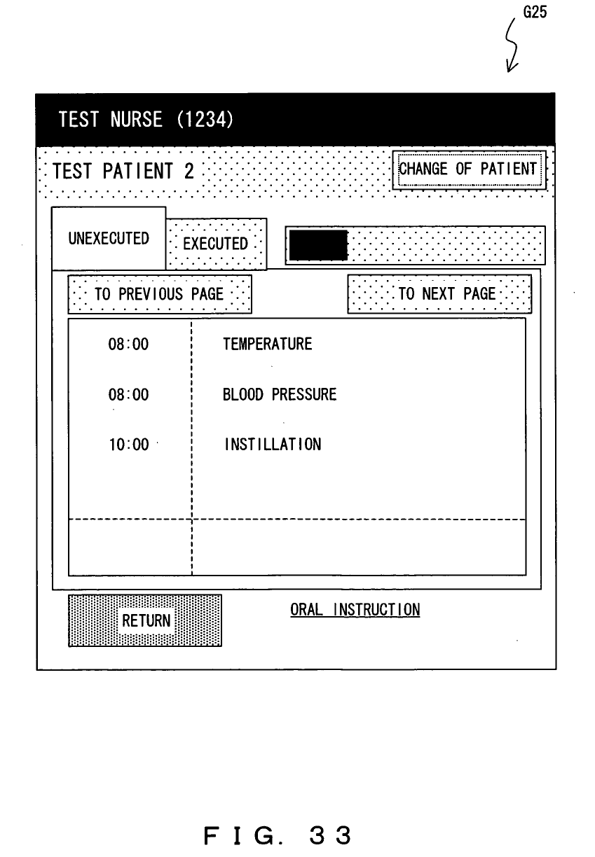

FIG. 33 shows an example of a medical execution screen of an oral instruction displayed on the PDA 8 when a normally scheduled medical execution order is executed issued by the oral instruction. A medical execution screen G25 of an oral instruction shown in FIG. 33 is similar to the display of a today's job display screen G7 shown in FIG. 13.

However, in the case of the medical execution screen G25 of the oral instruction, it is not a scheduled normal medical order. Therefore, there are no preceding or subsequent orders. So, the display of a button to the previous or next page is insignificant, thereby displaying the characters “oral instruction” in the marginal portion of the display area of the lower “return” button.

Then, the top executor name display area displays the name of the nurse “test nurse (1234)” who receives the oral instruction. In the lower portion, the name of a patient to be treated by medical execution of the order at the oral instruction is displayed as “test patient 2”.

In the central scheduled display area of medical execution, the scheduled medical execution input at the oral instruction by the test nurse (1234) who receives the oral instruction is displayed as the temperature at 8:00, the blood pressure at 8:00, and the instillation at 10:00. That is, the temperature and the blood pressure of the test patient 2 are to be measured at 8:00, and the instillation is to be measured at 10:00.

At the instruction, the test nurse (1234) first finishes the measurements of the temperature and the blood pressure of the test patient 2 at 8:00, and then visits the ward again for the instillation at 10:00.

The name data of the test nurse (1234), the name data of the test patient 2, and the data indicating the oral instruction order input on the PDA 8 are recorded in the database together with the input data after the medical execution scheduled in the scheduled medical execution.

Thus, the doctor who issues the oral instruction order accesses the hospital information management system 2 using the PC terminal 6 later through the server 7, opens the corresponding file, and checks the contents.

As an unscheduled inputting job, the input of the vital measurement result is described above, but the present invention is not limited to this application, but the blood sugar, SpO2 (oxygen saturation of blood), the phonocardiogram, the amount of meal, the amount of urine, etc. can also be input.

Next, in the determination in step S101 shown in FIG. 25, when an unscheduled inputting job does not occur, the test nurse (1234) executes a scheduled normal order (step S108). Then, the data input each time execution is completed is recorded in the server 7, and in the hospital information management system 2 from the server 7.

Described below is the case in which, in the process of executing a normally scheduled order in step S107, the medical execution is the above-mentioned instillation performed at 10:00, the test nurse (1234) tries to perform an injection (instillation) on the test patient 2, and the a break has been detected in the injection bottle (hereinafter referred to simply as a bottle, but the conventional glass bottles have been recently replaced with transparent and soft resin bag).

A break in a bottle can be a break before mixing medicines (any of the medicine to be mixed leaking out of its container or the container itself having a break) and a break after mixing medicines (a bottle carefully dropped after mixing medicines and the medicines spilling out, etc.).

Normally, the mixing process with a instillation bottle is performed by a nurse, and there is a nurse execution system exclusive for a mixing process so that no error occurs. If a break is detected relating to a single medicine before entering the process of the nurse execution system exclusive for the mixing process, a break inputting job is performed before a mixing process. If a break is detected relating to a bottle after completing the mixing process in the process of the nurse execution system exclusive for the mixing process, a break inputting job is performed after the mixing process.

When a break occurs during injection (for example, a case in which a mild patient carelessly upsets the bottle stand while walking in the hospital during the instillation, and the medicine spills out, etc.), the end-of-instillation job shown in FIG. 24B is performed. In this case, a dose input screen G14 shown in FIG. 22 is displayed on the display unit 18 of the PDA 8 of the nurse in charge.

However, in this case, the “amount of applied instillation” is displayed instead of the “amount of applied one-shot injection”, and the amount of applied instillation from the start of instillation to the occurrence of a break is input by estimating from the progress up to the occurrence of a break. For example, 55 (%) is input. The record is checked by a doctor in charge, and the 45% deficit in dose is recorded as a new order, and the dose is announced to the nurse, thereby the remaining instillation is performed according to the new order. When a needle extracted during instillation in a hospital room, the similar process is performed.

In the case of a break in a bottle before or after mixing, break data is input on a bottle label check screen G26. The break data is input in steps S109 through S111 and S106 shown in FIG. 26.

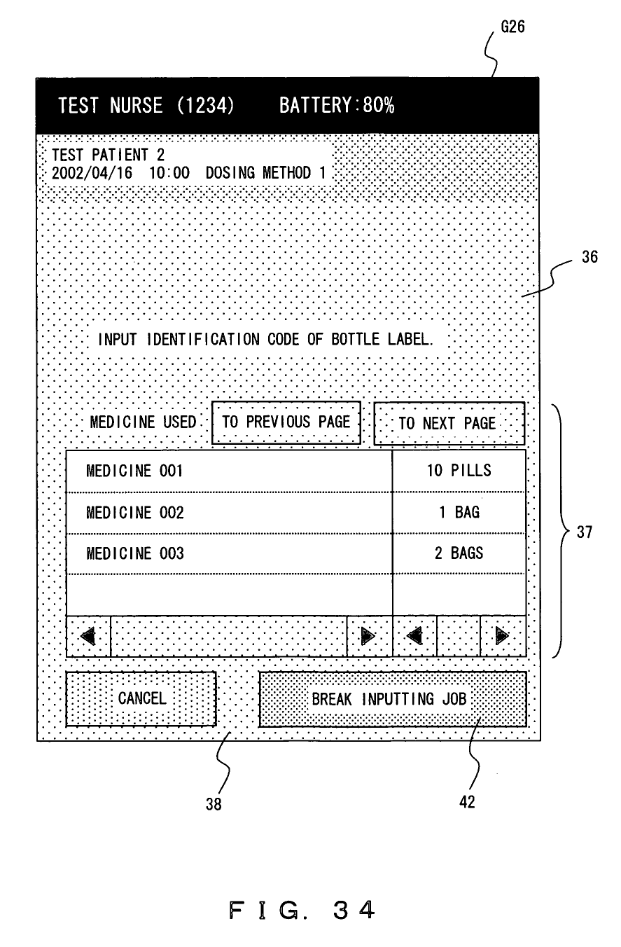

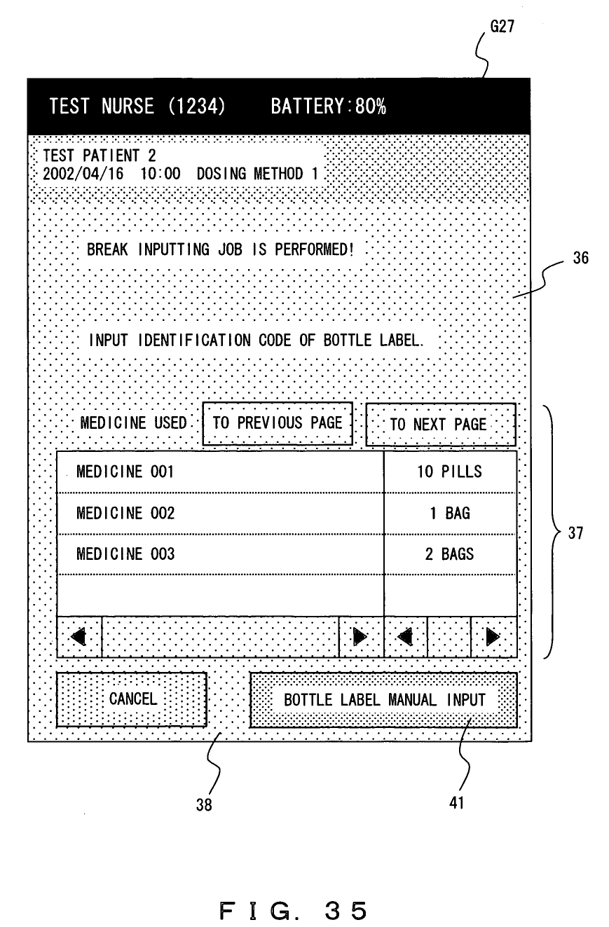

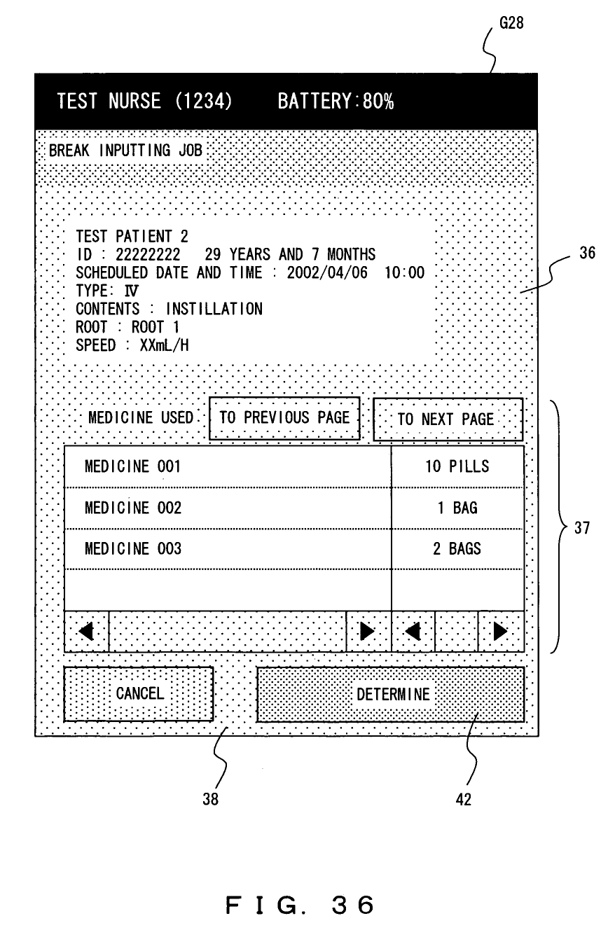

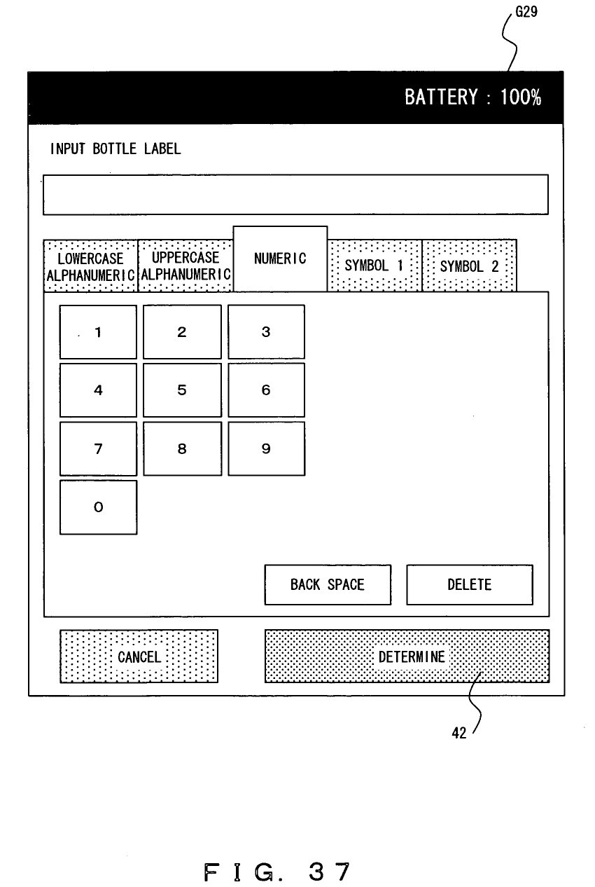

In the processes in steps S109 through S111, in addition to the bottle label check screen G25 shown in FIG. 34, a broken bottle label check screen G27 shown in FIG. 35, or a broken bottle check screen G28 shown in FIG. 36, and a broken bottle label manual input screen G29 shown in FIG. 37 are displayed on the PDA 8.

As shown in FIG. 34, on the bottle label check screen G26, the “test nurse (1234), battery: 80%” which shows the nurse in charge are displayed in the top portion, and the “test patient 2” which shows the name of the target patient are displayed on the second stage, below which “2002/04/16, 10:00, dosing method 1” which shows a instillation date and time and a dosing method are displayed. In a lower instruction message display area 36, an instruction “input the identification code of the bottle label” to the nurse is displayed.

In a lower bottle contents display area 37, “medicine used” is displayed in the upper portion, and the medicines “medicine 001”, “medicine 002”, and “medicine 003” used (or to be used) in the bottle is displayed in the lower portion. In the column on the right, the usage “10 pieces”, “1 bag”, and “2 bags” of the medicines are displayed.

If a break occurs in a bottle before inputting the identification code of the bottle label, then a break input button 39 displayed on the right of a button display area 38 at the bottom on the bottle label check screen G26 is pressed. Then, the display of a screen is switched to the broken bottle label check screen G27 shown in FIG. 35.

On the broken bottle label check screen G27, the display “a break inputting job is performed!” is added above the instruction message “input identification code of bottle label” in the instruction message display area 36 on the bottle label check screen G26, the display of the bottle contents display area 37 is unchanged, and the display of the button is changed into a “bottle label manual input” button 41 in the button display area 38 at the bottom.

When the test nurse (1234) reads the identification code of the bottle label using the reader of the PDA 8, the display of the PDA 8 is switched to the display of the broken bottle check screen G28 shown in FIG. 36.

On the broken bottle check screen G28, the name of a patient and its ID code, and data relating to the medical activities are displayed in the instruction message display area 36. The display in the bottle contents display area 37 is unchanged. In the button display area 38, the right button display is switched from the “bottle label manual input” button 41 to a “determination” button 42.

In FIG. 26, it is determined whether or not the bottle was broken before or after mixing (step S109).

If it is before the mixing process (YES in step S109), the name of the damaged medicine is touched and selected in the names of the medicines displayed in the bottle contents display area 37 (step S110).

In this case, although not specifically shown in the attached drawings, the background color of the display line of the selected medicine name is changed to another color, and the selection can be visually checked. If all damaged medicines are checked and selected, the test nurse (1234) presses the “determination” button 42 to record the damaged medicines in the server 7 (step S111).

When the damaged medicines are input and recorded in the server 7, an order to redeliver the damaged medicines is issued to the medicine department although not shown in FIG. 26, and the medicine department automatically transmits new medicines. Thus, the medicines to be mixed are input and recorded to resume the mixing.

In resuming the mixing, when an execution bottle (not shown in the attached drawings) is pressed, the execution of the mixing is recorded in the server 7.

If the break has occurred after the mixing (NO in S109), then the amount of the medicine lost by the break or the foreign substance which may have entered cannot be detected. Therefore, the break inputting job is performed on all medicines, and the “determination” button 42 is pressed. Thus, the status of all medicines are checked and recorded. In this case, the medicine department automatically transmits new medicines, and all medicines to be mixed are input and recorded, thereby resuming the mixing.

When the execution bottle (not shown in the attached drawings) is pressed in the mixing resuming process, the execution of the mixing is recorded in the server 7.

Thus, in the system of the present embodiment, it is possible to switch from the execution screen of an injection (instillation) immediately to the break inputting job, and to perform a break inputting job for each medicine.

In the above-mentioned break inputting job, the recognition code of the broken bottle is read by the PDA reader. Thus, if it is possible to read the recognition code of a broken bottle, the code is read and a break inputting job can be performed. However, if a break has made a spread or a spot of ink on the display of the recognition code, and the reader cannot read the code, then the recognition code has to be manually input.

If a recognition code cannot be automatically read in the system of the present embodiment, although not shown in FIG. 26, then the lower right “bottle label manual input” button 41 is pressed when the broken bottle label check screen G27 is displayed. The screen is switched to the broken bottle label manual input screen G29 shown in FIG. 37.

On the broken bottle label manual input screen G29, ten-keys and process keys required in manually inputting a recognition code are displayed. The test nurse (1234) manually inputs a recognition code using the ten-keys and other process keys, and presses the “determination” button 42.

Thus, in any case, the recognition code of a broken bottle can be input.

When a nurse cannot read an identification code, the code can be restored by considering various data such as the mixing data card, the matching data of the server, etc. The consideration data is not checked by the hospital information system 1, but the staff in the field appropriately considers each case.

When measured data is displayed on the monitor screen to check the condition of a patient, measured values are displayed with reference values so that the condition of the patient can be observed by referring to the difference between the reference values and the measured values. The reference values are set to fixed values. For example, a blood pressure in accordance with the international standards is 140 mmHg. The temperature, the pulse, the aspiration, etc. are also set to fixed values in many cases.

However, for example, as for an upper limit of a blood pressure, some people do not indicate abnormal conditions at 170 mmHg while others indicate abnormal conditions at a little higher than 140 mmHg.

Furthermore, some people record their normal temperatures of 36 degrees while others record their normal temperatures lower than 36 degrees. For those having their normal temperatures over 36 degrees, the temperature of 37 degrees is slight fever while for those having their normal temperatures lower than 36 degrees, the temperature of 37 degrees is high fever. Therefore, the measured value of 37 degrees is not simply acceptable.

The pulses and the aspiration of those who receive physical practice are lower, but the pulses and the aspiration of those who seldom have physical practice are normally higher. Therefore, if the pulses and the aspiration of a person who normally takes physical practice become high due to illness, and the increased pulses and aspiration are almost the same as those of a person who takes no physical practice, then it is considered that the condition of the person who normally takes physical practice is more serious than the condition of the person who takes no physical practice.

Thus, the data obtained by the vital measurements are not simple, and are not automatically diagnosed. After an operation, all vital measurement values normally rise.

Therefore, when the above-mentioned measured values and reference values are conventionally displayed together and observed, and when a measured value deviates from a reference value and exceeds the reference value, the excess portion is displayed in a specific color to attract attention. This method is used to recognize a worse change of the condition of a patient. However, since the value is to be checked based on the above-mentioned personal considerations, the measured value can be displayed as exceeding the reference value on the display of the monitor although it is a permissible value for the person when the measured value is compared with the fixed reference value.

Therefore, the factors other than the reference value such as a worse condition of a patient, a temporary worse condition after an operation, a measured value exceeding a reference value due to the physical characteristics of a patient, etc. are to be considered when a measured value is read so that a correct diagnosis can be made. That is, when a measured value and a reference value are displayed together for observation, the values can be read by an experienced user only, and cannot be easily read by a common user.

However, in the hospital information system according to the present embodiment, a monitor display method in which any user can easily make a diagnosis with a measured value and a reference value displayed together can be realized.

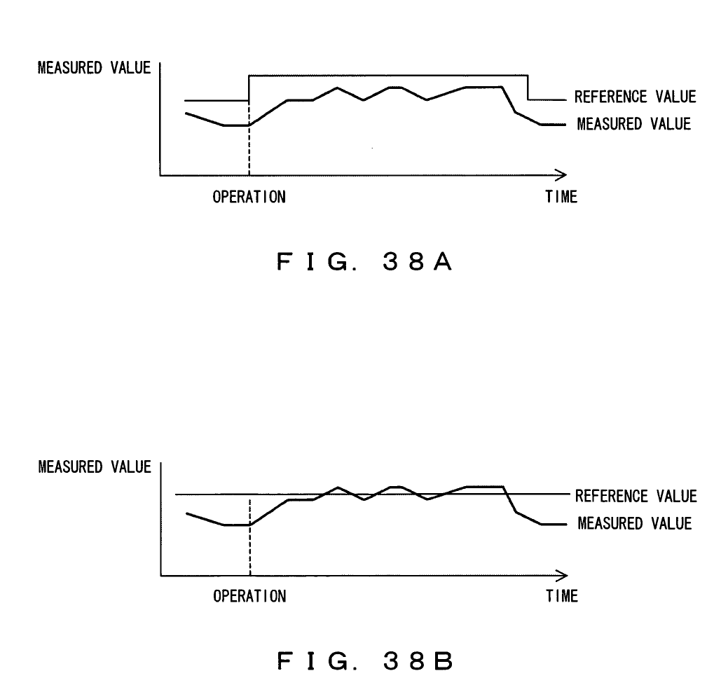

FIG. 38A shows the monitor display method of the present embodiment, and FIG. 38B shows the conventional monitor display method for reference. FIGS. 38A and 38B show a lapse of time after an operation along the horizontal axis, and a vital measurement value along the vertical axis. The vital measurement value is a representative value of the temperature, pulse, blood pressure, or aspiration of a patient.

Since FIG. 38B shows a fixed value of a reference value regardless of an operation or the personal characteristic of a patient, and shows an example of the measured value exceeding the reference value on the display of the monitor although the measured value is in a permissible range for the patient.

On the other hand, according to the present embodiment, as shown in FIG. 38A, the reference value rises after the operation. Thus, in the present embodiment, the doctor in charge amends and raises the reference value by considering the rise of a vital measurement value, for example, after an operation. Furthermore, the doctor raises or drops the reference value with the personal physical characteristic of a patient taken into account. In any case, the reference value is raised from a fixed value.

Thus, the measured data (measured value) output from the PDA 8 to the server 7 is changed for a corresponding patient, associated with the set reference value, and recorded in the server. The result is displayed on the monitor.

Since the reference value is changed and displayed depending on the medical environment and the physical characteristic of a patient, a measured value does not insignificantly exceed a measured value as far as the condition of a patient is normal, but changes within a permissible range of the reference value. Therefore, any user can easily check the condition of a patient by observing whether or not the measured value exceeds the reference value.

If a measured value exceeds a reference value, then a user can be informed that the condition of a patient has changed for the worse. Inversely, the user can also be easily informed of a better change. If a reference value can be reset from the PC terminal 6 or the PDA 8 depending on the condition of a patient as necessary, then the reference value can be displayed constantly in a correct permissible range on the monitor.

Thus, according to the present embodiment, when medical activities are executed at an execution site, the contents of the job schedule of the medical activities can be checked on the PDA 8 as a mobile terminal, and the medical activities of the job schedule can be performed after checking the contents of the job schedule. Therefore, the medical activities to be executed (scheduled) can be correctly performed with less errors.

Furthermore, since time-consuming medical activities can also be correctly grasped, the information about a delay of the actual medical activities can be quickly issued. Therefore, the staff involved can easily accept a schedule change, thereby obtaining an environment of smoothly performing medical activities.

Additionally, since the contents of medical activities can be recorded using the PDA 8 at an execution site of medical activities, the medical activities can be recorded by checking the progress of the activities immediately after the execution, thereby successfully making a record correctly with less errors.

After checking the job schedule of medical activities using the mobile PDA 8, and correctly performing and recording the medical activities of the job schedule, the contents of the medical activities are transferred to an execution list based on which the executor can smoothly perform the medical activities of a plurality of job schedules by referring to a job schedule list.

When medical activities are executed, the job schedule contents can be easily referred to and checked at any place and time, and smoothly performed using the mobile PDA 8. Furthermore, when the job schedule contents are changed, the change of the job schedule contents can be easily accepted by checking the job schedule contents immediately before the execution.

When the medical activities are executed, the execution contents can be correctly recorded, that is, recorded in real time. Therefore, the system can be more efficiently improved by later analyzing the recorded data.

In the explanation above, when the medical activities of the job schedule are performed and the executed contents, etc. are input, the data is transmitted to the hospital information management system 2 through the server 7 and recorded in the database. In this case, the checking process of the input contents and the transmitting process to the hospital information management system 2 can be continuously performed.

For example, the input of the execution contents is displayed on the PDA 8 and checked by the check button. After the check, a confirmation message asking whether or not the data is to be transmitted for record in the database is issued, and the transmission can be executed using an OK button or other process buttons.

If the hospital information management system 2 enters the standby state to receive transmission because it is performing any job after the transmission for recording, then, for example, the server 7 of the PDA system 4B receives the contents, and records the contents received by the server 7 in the database of the hospital information management system 2 after the standby state of the hospital information management system 2 is released. When the contents are completely recorded, the PDA 8 can be informed of the completion of recording the contents.

Thus, the executor who is recording the contents using the PDA 8 can be free of the inconvenience of awaiting the release of the standby state of the hospital information management system 2.

The PDA 8 realizes the processes of obtaining information transmitted from the hospital information management system 2, outputting and displaying the information on the display unit 18, or obtaining the input of the information corresponding to the process on the process input unit 17 by the user and transferring the information to the hospital information system 1 by the CPU 13 executing the application program stored in the storage unit 16. Described below is the process for update of the application program in the hospital information system 1.

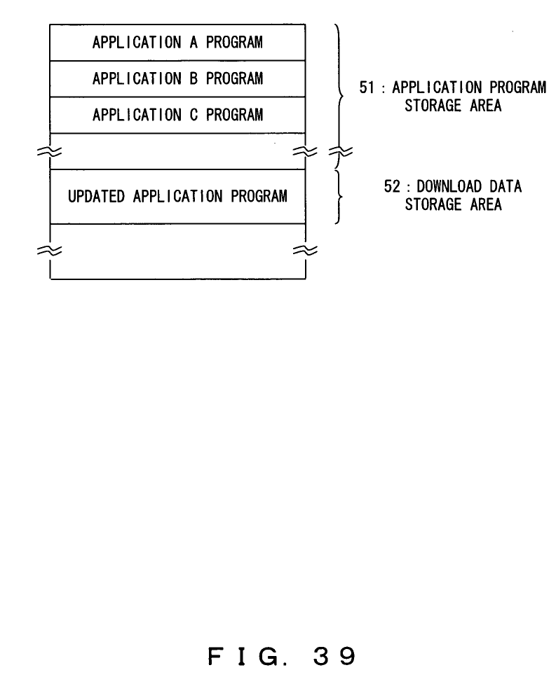

Described first is the process shown in FIG. 39. FIG. 39 shows the assignment of the storage area of the storage unit 16 of the PDA 8.

In FIG. 39, an application program storage area 51 is an area storing various application programs executed by the CPU 13, and a download data storage area 52 is an area storing the data downloaded from the server 7 to the PDA 8 through the wireless LAN 9. In the present embodiment, to update the application stored in the application program storage area 51, the updated application program is downloaded from the server 7 and stored in the download data storage area 52.

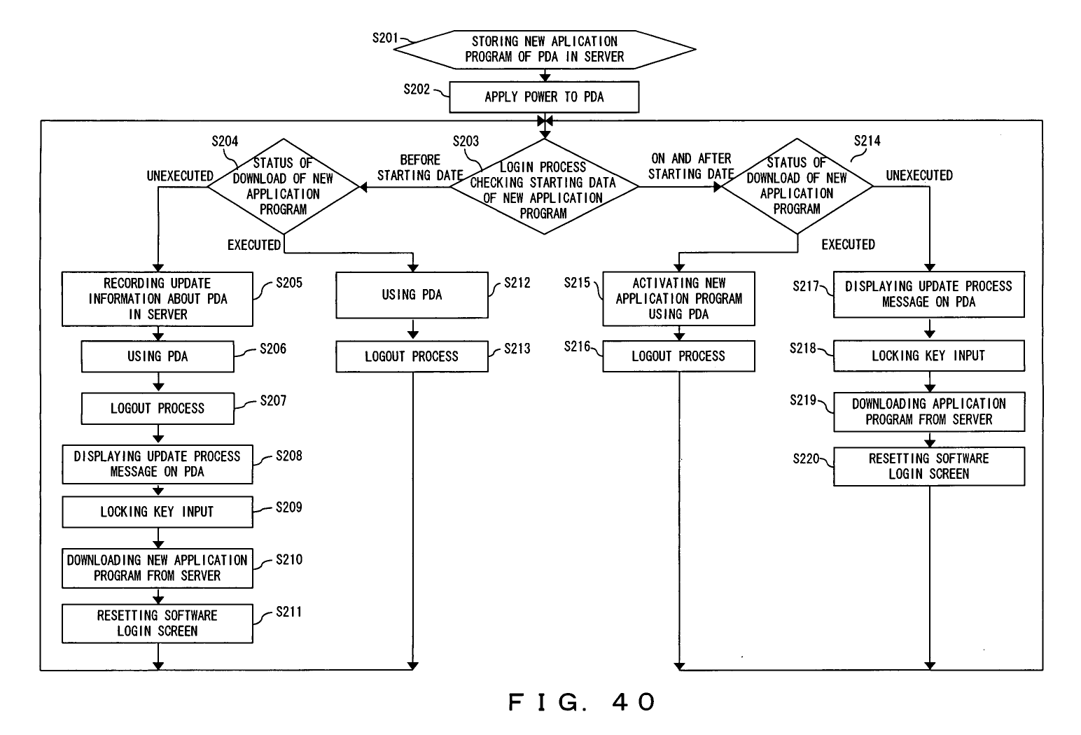

Described below is the process shown in FIG. 40. FIG. 40 shows the procedure of the process of updating the application program executed in the PDA system 4B and used in the PDA 8.

First, in S201, the updated application program to be started up by the PDA 8 on and after a predetermined day (hereinafter referred to as a “new application program”) is stored in the storage unit of the server 7 before the starting date.

When electric power is applied to the PDA 8 (when the PDA 8 is turned on) in S202, the PDA 8 logs on to the server 7 in S203. At this time, the server 7 checks the starting date of the new application program to determine whether or not the current date and time has exceeded the starting date. If the current time and data has not exceeded the starting date, then control is passed to S204. If it has exceeded the starting date, then control is passed to S214.

Since the starting date of the new application program in the PDA 8 is centrally managed by the server 7 in the process in S203 above, the user on the PDA 8 is not charged with the load of determining the start-up of the new application program.

In S204, the server 7 determines whether or not the new application program has been downloaded in S203 to the PDA 8 which logged in to the server. If the new application program has not been downloaded yet, control is passed to S205. If it has been downloaded, control is passed to S212. The determination in S204 is performed based on the history of the download of the new application program in the update information of the PDA 8 recorded by the server 7.

In S205, the history of the download of the new application program is recorded in the update information of the PDA 8 recorded in the server 7.

In S206, the application program before update stored in the application program storage area 51 of the storage unit 16 is executed by the CPU 13 so that each function of the PDA 8 can be provided, and various data relating to the above-mentioned medical activities can be input/output. Thus, each function is available by a nurse.

When the use of the PDA 8 is completed, a logout request is transmitted from the PDA 8 to the server 7 in S207, and the logout process for disconnection from the PDA 8 is performed in the server 7. The process of the PDA 8 performed while the logout process is performed is described later.

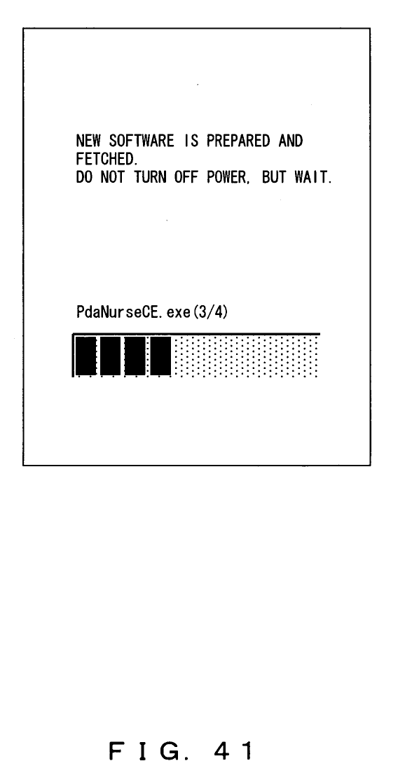

Then, in S208, the screen for notification to the user of the PDA 8 that the process relating to the update of a program is being performed, such as shown in FIG. 41, is displayed on the display unit 18.

In S209, the input of a process by the PDA 8 to the process input unit 17 is locked and ignored. The process is performed so that the downloading process does not to receive the influence of the PDA 8 operated when a new application program is downloaded. With an emergency taken into account, the power switch can be released from the locking operation.

In S210, a new application program is downloaded from the server 7 to the PDA 8. In the PDA 8, the downloaded new application program is temporarily stored in the download data storage area 52 of the storage unit 16.

In S211, the reset process of the CPU 13 by software is performed, the process of downloading a new application program from S208 to S210 is completed, and the display unit 18 of the PDA 8 displays the login screen for use in issuing a login request to the server 7. After the reset, the application program before the update stored in the application program storage area 51 of the storage unit 16 is still used.

As described above, the new application program is downloaded after the logout process because the logout process is performed when the use of the PDA 8 terminates, but no problems occur although the functions of the PDA 8 cannot be used then.

When it is determined in S204 that the new application program has been downloaded, then the application program not updated and stored in the application program storage area 51 of the storage unit 16 is executed by the CPU 13, thereby providing each function of the PDA 8, and enabling various data relating to the above-mentioned medical activities to be input/output and used by nurses in S212.

After the use of the PDA 8 terminates, the logout request is transmitted from the PDA 8 to the server 7, and the server 7 performs the logout process for disconnection from the PDA 8 in S213, and then the procedure from S203 is repeated. The process of the PDA 8 in the logout process in S213 is somewhat different from the process in S207 as described later.

If it is determined in S203 that the current date and time has exceeded the starting date of the new application program, then the server 7 determines in S214 whether or not the application program has been downloaded to the PDA 8 which has logged in S203. If the new application program has not been downloaded, control is passed to S217. If it has been downloaded, then control is passed to S215. The determination in S214 is performed based on the history of the download of the new application program according to the update information about the PDA 8 stored in the server 7 as in the determination process in S204.

In S215, according to the history of installing a new application program in the update information about the PDA 8 stored in the server 7, it is determined whether or not a new application program has been installed. If a new application program has not been installed, the new application program stored in the download data storage area 52 of the storage unit 16 is overwritten and stored in the area in which the application program before the update has been stored (update of a program), thereby performing the reset process of the CPU 13 by software, and displaying the login screen for use in issuing a login request to the server 7 on the display unit 18 of the PDA 8. The new application program is read from the application program storage area 51 and executed by the CPU 13. When a new application program has been installed in S215, the new application program is similarly read and executed. By updating the application program, the PDA 8 can provide a new function, thereby allowing the nurse, etc. to use the new function.

When the use of the PDA 8 terminates, in S216, a logout request is transmitted from the PDA 8 to the server 7 and the server 7 performs the logout process similar to that in S213. Afterwards, the procedure from S203 is repeated.

If it is determined in S214 that a new application program has not been installed, then the display unit 18 displays in S217 the screen of notifying the user of the PDA 8 that the process relating to the update of the program as shown in FIG. 29 is being performed.

In S218, as in S209, the process input to the process input unit 17 of the PDA 8 is locked and ignored.

In S219, a new application program is downloaded from the server 7 to the PDA 8. In the PDA 8, the downloaded new application program is temporarily stored in the download data storage area 52 of the storage unit 16. The downloaded new application program can be directly overwritten to the application program storage area 51 to update the program.

In S220, the CPU 13 performs the reset process by software, a new application program is downloaded from S208 through S210, and the display unit 18 of the PDA 8 displays the login screen for use in issuing a login request to the server 7. Afterwards, the procedure from S203 is repeated. After the reset, the login process is performed again, control is passed from S203 to S214 and S215, and the use of the new application program is started.

Thus, the application program used in the PDA 8 can be updated.

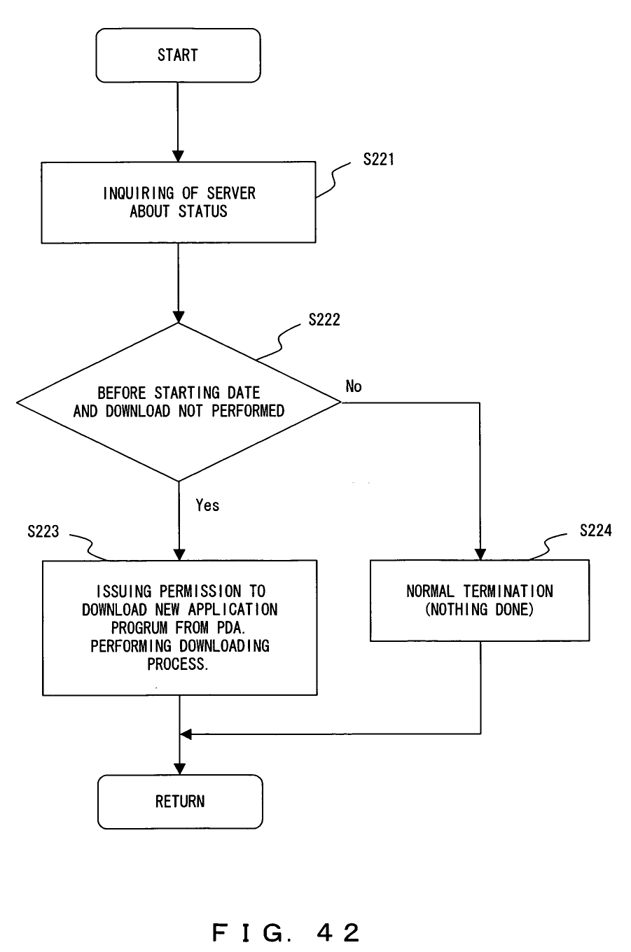

Next, the logout process performed by the PDA 8 in each of S207, S213, and S216 shown in FIG. 40 is explained below by referring to FIG. 42.

When the logout process is started, an inquiry about whether or not the current date and time has exceeded the starting date of the new application program, and whether or not the new application program has already been downloaded to the PDA 8 is issued from the PDA 8 to the server 7 first in S221. In S222, based on the response to the inquiry, it is determined whether or not the current date and time has not exceeded the starting date of the new application program, and the new application program has been downloaded to the PDA 8.

If the determination result is YES, then, in S223, a permission notification that the preparation for the download of a new application program has been made is transmitted from the PDA 8 to the server 7, and the PDA 8 starts performing the download process of a new application program. Afterwards, control is returned to the procedure shown in FIG. 40. When the determination result in S222 is YES, the logout process is being performed in S207 shown in FIG. 40. By the PDA 8 performing the downloading process, the new application program downloaded from the server 7 in S210 shown in FIG. 40 is temporarily stored in the download data storage area 52 of the storage unit 16.

If the determination result in S222 is NO, the PDA 8 performs the process of normally terminating the use in S224. Afterwards, control is returned to the procedure shown in FIG. 40. The determination result in S222 is NO when the logout process is being performed in S213 or S216 shown in FIG. 40.

The PDA 8 performs the above-mentioned process when the logout process is performed.

As described above in detail, various effects can be obtained by embodying the present invention.

For example, according to the present invention, a mobile terminal enables the record of medical activities to be made at an execution site of the medical activities, thereby making a correct record and grasping the medical activities in real time. Furthermore, the mobile terminal can reduce the laborious job of collecting data for the medical activities, and grasping the contents, progress, results, etc. of the medical activities.

Additionally, according to the present invention, a mobile terminal can refer to the job schedule data generated by the hospital information management system independent of the place and time, and supports the executor of medical activities such as a nurse, etc. who uses and carries the mobile terminal. Furthermore, the working hours and the job schedule of an executor who performs the medical activities can be freely referred to by reference to a patient, etc., thereby smoothly performing the medical activities to be executed. Additionally, the reference style can be changed depending on the purpose of a job, and necessary information can be referred to in an appropriate format for each purpose of a job, thereby smoothly executing medical activities.

According to the present invention, a possible error in performing an injection executed in a hospital room of a patient can be avoided.

According to the present invention, a time-consuming medical activity such as a instillation, etc. can be correctly grasped. Additionally, since a time-consuming medical activity can be correctly grasped, a possible time delay in actually executing the medical activity can be immediately announced, and the schedule change can be easily accepted. Therefore, medical activities can be smoothly performed.

Furthermore, according to the present invention, not only normal medical activities can be executed and recorded by a mobile terminal at an execution site of the medical activities by a nurse, but also an unscheduled measurement and a process to be performed on a break of a bottle can be executed by a mobile terminal. Therefore, the load of a nurse can be largely reduced. Since an unscheduled medical activity (unscheduled examination) can be associated with a purpose and an instruction issuer, and input and recorded as necessary using a mobile terminal, a necessary process after the unscheduled examination can be easily performed.

According to the present invention, the load of a user of the terminal for changing a program used in the terminal can be reduced.

Furthermore, the above-mentioned effects of the present invention are examples only, and the present invention is not limited to them.

The present invention is not limited to the above-mentioned embodiments, but can be improved and amended in various manners.

1. An information system for use in a hospital, comprising:
a plurality of subsystems comprising:
a terminal inputting and outputting data relating to medical activities;
a server controlling the data; and
a hospital information management system managing the data processed in the subsystems, wherein
said server controls communications of the data between said terminal and said hospital information management system; and
at least one of said plurality of subsystems comprises a mobile terminal capable of communicating data of the medical activities to be input and output at an execution site of the medical activities with said hospital information management system.

2. The system according to claim 1, wherein
said terminal communicates the data with said hospital information management system through a wireless communications line.

3. The system according to claim 1, wherein
said terminal further comprises a read unit reading identification information.

4. In information system which manages information relating to medical activities on patients at different places, comprising:
an information management system managing information about more than one predetermined medical facilities;
a mobile terminal inputting and outputting data relating to the medical activities executed at an execution site where the medical activities are executed in the medical facilities; and
a server controlling communications of medical activity data between said mobile terminal and said hospital information management system.

5. An information system for use in a hospital, comprising:
a mobile terminal inputting and outputting data relating to medical activities at an execution site of the medical activities in a hospital;
a hospital information management system managing information in the hospital; and
a server controlling communications of data relating to medical activities between said mobile terminal and said hospital information management system.

6. The system according to claim 5, further comprising:
a stationary terminal inputting and outputting data relating to medical activities; and
a second server controlling communications of medical activity data between said stationary terminal and said hospital information management system.

7. The system according to claim 5, further comprising
an order entry unit recording an order relating to medical activities wherein:
said hospital information management system comprises:
a job schedule data generation unit generating job schedule data indicating a job scheduled to be executed in response to the order recorded by said terminal; and
said mobile terminal comprises:
a job schedule data acquisition unit obtaining the job schedule data generated by said hospital information management system; and
a display control unit displaying the job schedule data on said mobile terminal.

8. The system according to claim 7, wherein
said mobile terminal displays the job schedule data designated at an instruction to select from among options of working hours, patients, wards, and job types.

9. The system according to claim 7, wherein
said mobile terminal displays job schedule data obtained by said job schedule data acquisition unit or obtained by designating the job schedule data by said display control unit.

10. The system according to claim 7, wherein
said mobile terminal designates the job schedule data by said job schedule data acquisition unit obtaining only the job schedule data corresponding to the instruction relating to the working hours or said display control unit controlling a display of the job schedule data only corresponding to the instruction, and displays the designated job data.

11. The system according to claim 7, wherein
said mobile terminal designates the job schedule data by said job schedule data acquisition unit obtaining only the job schedule data corresponding to the instruction relating to the patients or said display control unit controlling a display of the job schedule data only corresponding to the instruction, and displays the designated job data.

12. The system according to claim 7, wherein
said mobile terminal designates the job schedule data by said job schedule data acquisition unit obtaining only the job schedule data corresponding to the instruction relating to the job types or said display control unit controlling a display of the job schedule data only corresponding to the instruction, and displays the designated job data.

13. The system according to claim 7, wherein
said mobile terminal designates the job schedule data by said job schedule data acquisition unit obtaining only the job schedule data corresponding to the instruction relating to the wards or said display control unit controlling a display of the job schedule data only corresponding to the instruction, and displays the designated job data.

14. The system according to claim 5, wherein
said medical activities includes an activity belonging to any of an injection, nursing, a treatment, and examinations and measurement.

15. The system according to claim 7, wherein
said display control unit allows said mobile terminal to display the job schedule data as sorted into data of unexecuted jobs and data of executed jobs, and, when an unexecuted job is input to said mobile terminal as an executed job, transfers the job schedule data from an unexecuted job group to an executed job group.

16. The system according to claim 5, wherein
said hospital information management system manages a job execution schedule relating to medical activities performed on patients, and
said information system compares patient identification information assigned to a patient for identification of the patient and container identification information assigned to a container for identification of the container containing an injection medicine to be dosed to a patient by an injection to be performed on the patient with an instruction of an injection for the patient listed in the execution schedule, and outputs contents of the instruction from said mobile terminal when a comparison result refers to matching.

17. The system according to claim 16, wherein
in the comparison, the container identification information is first compared with the instruction, and when it is determined that the comparison result refers to matching, the patient identification information input to the terminal is compared with the instruction.

18. The system according to claim 5, wherein
said hospital information management system manages an execution schedule of a job of medical activities performed on a patient, and when container identification information assigned to a container containing an injection medicine to be dosed to a patient by an injection is transmitted from said mobile terminal, searches a job execution record relating to the medical activities for an execution record about a checking process of a medicine mixed in the container and instructed to be dosed to the patient by the injection.

19. The system according to claim 18, wherein
when the execution record about the checking process is detected, said hospital information management system transmits the presence of the execution record to said mobile terminal.

20. The system according to claim 5, wherein:
said hospital information management system manages a job execution schedule about medical activities performed on a patient;
when container identification information indicated on a container for identification of the container containing an injection medicine to be dosed to the patient by an injection is input to said mobile terminal, said information system determines whether or not an instruction about the injection for the patient contained in the execution schedule has been changed after the indication of the container identification information on the container.

21. The system according to claim 20, wherein:
said container identification information can contain change information indicating that the instruction about the injection for the patient contained in the execution schedule has been changed after indicating the container identification information on the container separately from information for exclusive identification of the container; and
when the instruction about the injection for the patient in the execution schedule has been changed, said hospital information management system manages the container identification information changed to indicate the change information showing the change as information showing an instruction about an injection for the patient in the execution schedule.

22. An information system for use in a hospital, comprising:
a terminal inputting execution data about executed medical activities; and
a hospital information management system managing execution data input to said terminal, wherein
said terminal separately inputs starting data indicating that medical activities have been started and ending data indicating that the medical activities have been completed.

23. The system according to claim 22, wherein said medical activities are instillation.

24. The system according to claim 22, wherein said terminal is a mobile terminal.

25. The system according to claim 22, wherein
said starting data and ending data indicate date and time data together with an executor of a medical activity, an execution site of the medical activity, execution contents of the medical activity, and a patient who receives the medical activity.

26. The system according to claim 22, wherein
upon receipt of the starting data, said hospital information management system compares a time at which a job for completing a medical activity relating to the starting data with a scheduled time of the job for completing the medical activity, and changes the scheduled time based on a comparison result.

27. An information system for use in a hospital, comprising:
a terminal inputting and outputting data relating to medical activities;
a server system communicating the data with said terminal; and
a hospital information management system recording information communicated by said server system in the hospital, and centrally managing the information, wherein
said terminal comprises:
a scheduled medical job data input/output unit inputting and outputting data of medical activities normally scheduled and transmitted as instructions from said server system according to a medical order; and
an unscheduled medical job data input/output unit inputting and outputting data of medical activities unscheduled and not transmitted as instructions from said server system.

28. The system according to claim 27, wherein
data of an unscheduled medical activity data is measurement data relating to an unscheduled measurement.

29. The system according to claim 28, wherein
measurement data relating to the unscheduled measurement includes measurement data of at least a temperature, pulses, aspiration, or a blood pressure.

30. The system according to claim 27, wherein
data of an unscheduled medical activity is medicine name data indicating a name of a medicine in a broken injection bottle.

31. The system according to claim 30, wherein
said unscheduled medical job data input/output unit inputs the name of the medicine in the broken injection bottle by reading an identification code attached to the injection bottle by an identification code reader provided for said terminal, or by a user of said terminal manually inputting the code.

32. An information system for use in a hospital, comprising:
a terminal inputting and outputting data by executing a program; and
a server system communicating the data with said terminal; wherein:
when a request to terminate a connection between said terminal and said server system is received from said terminal, said server system transmits, to said terminal, data for update of a program being executed by said terminal; and
said terminal updates the program based on the data transmitted from said server system and used for the update.

33. An information system for use in a hospital, comprising:
a terminal inputting and outputting data by executing a program; and
a server system communicating the data with said terminal; wherein:
said terminal updates the program being executed by said terminal based on the data transmitted from said server system and used for update of the program;
when the request for a connection between said terminal and said server system is transmitted from said terminal, said server system transmits information about availability of an updated to said terminal; and
when the information transmitted from said server system indicates that the updated program is available, said terminal executes the updated program, and inputs and outputs the data.

34. An information system for use in a hospital, comprising:
a terminal inputting and outputting data by executing a program; and
a server system communicating the data with said terminal; wherein:
said server system contains data for use in updating a program being executed by said terminal, and can set in said server system a starting date from which the program is available by said terminal after update;
said terminal is configured to update the program based on the data transmitted from said server system for use in the update;
when said server system is connected to said terminal before the set starting date and the data for use in the update is not transmitted from said server system to said terminal, said server system transmits the data to the terminal to store the data in;
when said server system is connected to said terminal after the set starting date and the data for use in the update is transmitted from said server system to said terminal, said server system allows said terminal to update the program based on the data; and
when said server system is connected to said terminal after the set starting date and the data for use in the update is not transmitted from said server system to said terminal, said server system transmit the data to said terminal and allows said terminal to store the data and update the program based on the data.

35. The system according to claim 32, wherein
data input and output by said terminal relates to medical activities.

36. The system according to claim 32, wherein
said terminal ignores other input to said terminal when said terminal receives data from said server system for use in updating the program.

37. A server system which is a component of an information system for use in a hospital, comprising:
a data communications device communicating data with a terminal which is a component of the information system and inputs and outputs data by executing a program; and
an update data transmission unit transmitting, to the terminal, data for use in updating a program being executed by the terminal when a request to terminate a connection is received from the terminal.

38. A server system which is a component of an information system for use in a hospital, comprising:
a data communications device communicating data with a terminal which is a component of the information system and inputs and outputs data by executing a program;
an update data transmission unit transmitting, to the terminal, data for use in updating program being executed by the terminal; and
a program availability information transmission unit transmitting information about availability of a program after update to the terminal when a request for a connection is received from the terminal.

39. A terminal which is a component of an information system for use in a hospital, comprising:
an input/output unit inputting and outputting data by executing a program;
a data communications device communicating the data with a server system which is a component of the information system; and
a program update unit updating the program based on data transmitted from the server system for use in updating the program, wherein
said input/output unit inputs and outputs data by executing an updated program when information transmitted from the server system at a request transmitted to the server system to connect to the server system indicates availability of the updated program.
